(19) United States
(12) Patent Application Publication
(10) Pub. No.: US 2012/0208120 A1
(43) Pub. Date: Aug. 16, 2012

(54) TONER FOR USE IN THE DEVELOPMENT OF ELECTROSTATIC LATENT IMAGES, ELECTROSTATIC LATENT IMAGE DEVELOPER, AND IMAGE FORMING METHOD

(75) Inventors: Masanobu NINOMIYA, Kanagawa (JP); Jun IGARASHI, Kanagawa (JP); Toshiyuki YANO, Kanagawa (JP); Hiroshi NAKAZAWA, Kanagawa (JP)

(73) Assignee: FUJI XEROX CO., LTD., Tokyo (JP)

(21) Appl. No.: 13/454,961

(22) Filed: Apr. 24, 2012

Related U.S. Application Data
(63) Continuation of application No. 10/956,256, filed on Oct. 4, 2004, now abandoned.

(30) Foreign Application Priority Data
Mar. 11, 2004 (JP) 2004-068956

(51) Int. Cl. G03G 9/087

(52) U.S. Cl. 430/110.3

(57) ABSTRACT

A toner for use in the development of electrostatic latent images contains colored particles including at least a binder resin, a coloring agent and a releasing agent, and an external additive. An average circularity of the toner is 0.975 or more; a median of arithmetic average height distribution of the toner is 0.05 μm or more and not more than 0.12 μm; and a fluctuation of arithmetic average height is not more than 35. Preferably, a value of 90% accumulation of the arithmetic average height distribution of the toner is less than 0.15 μm; and a fluctuation of number average particle size and a fluctuation of circularity of the toner are not more than 25 and not more than 2.5, respectively. The electrostatic latent image developer contains the foregoing toner and a carrier, and the image forming method uses the foregoing toner or the, foregoing developer.

This is a new U.S. Continuation Application of prior pending U.S. application Ser. No. 10/956,256, filed Oct. 4, 2004, which claims priority to Japanese Patent Application No. JP-2004-068956 filed Mar. 11, 2004.

### BACKGROUND OF THE INVENTION

1. Field of the Invention

The present invention relates to a toner for use in the development of electrostatic latent images, an electrostatic latent image developer and an image forming method, each of which is used for the purpose of developing electrostatic latent images in the electrophotographic process, the electrostatic recording process, and so on.

2. Description of the Related Art

So far, in the case of forming images in copy machines, laser printers, etc., the Carlson method is generally employed. In the conventional image forming method according to the black-and-white electrophotographic process, an electro-static latent image formed on the surface of a photoreceptor (electrostatic latent image carrier) is developed with a toner for use in the development of electrostatic latent image (hereinafter simply referred to as “toner”), the resulting toner image is transferred onto the surface of a recording medium, and the transferred toner image is fixed by a heat roller, etc. to obtain a black-and-white image. Also, the electrostatic latent image carrier is to be removed from the residual toner after the transfer for the purpose of again forming an electrostatic latent image.

In recent years, in the technical development of electrophotography, development from black-and-white to full color is being rapidly made. The color image formation by the full color electrophotographic process generally achieves reproduction of all colors using four color toners including a black toner in addition to toners of three colors of yellow, magenta and cyan as three primary colors.

In the general full color electrophotographic process, an original is first color separated into yellow, magenta, cyan and black, and electrostatic latent images are then formed on the surface of a photoconductive layer (electro-static latent image carrier) for every color. Next, the foregoing steps are successively repeated in the plural number of times, and the toner images are superposed on the same recording medium surface while performing registering. Then, a full color image is obtained by one fixing step. In this way, what several kinds of toner images having a different color are superposed is a large difference between the black-and-white electrophotographic process and the full color electrophotographic process.

In the foregoing full color images, a desired image is formed by superposing three-color or four-color color toners. Accordingly, if any one of these colors exhibits characteristics different from those at the initial stage in the development, transfer or fixing step or exhibits a performance different from other colors, a lowering of the color reproducibility, deterioration of graininess, and deterioration of image quality such as color unevenness will be caused. In recent years, with respect to the image quality of full color images, a high image quality grade is desired. If such changed of characteristics of toner occur, it becomes difficult to obtain stable high image qualities. Accordingly, improvements of characteristics in the development, transfer and fixing steps and an enhancement of the stability of characteristics become more important.

On the other hand, in recent years, from the viewpoint of environmental protection, the technologies are gradually changing over from the non-contact charge/transfer method utilizing corona discharge which has hitherto been employed to the contact charge method or contact transfer method using an electrostatic latent image carrier-contact member. In the contact charge method or contact transfer method, a conductive elastic roller is brought into contact with an electrostatic latent image carrier, and the electrostatic latent image carrier is uniformly charged while applying a voltage to the conductive elastic roller and then exposed (latent image forming step) ; and after forming a toner image by a development step, the toner image is transferred onto the surface of an intermediate transfer body having a voltage applied thereto while pressing the intermediate transfer body to the electrostatic latent image carrier. Further, a recording medium such as paper is passed between the intermediate transfer body and another conductive elastic roller having a voltage applied thereto while pressing the conductive elastic roller to the intermediate transfer body, thereby transferring the toner image onto the recording medium, and fixed image is then obtained after a fixing step.

However, in such a transfer system, since an intermediate transfer member such as the intermediate transfer body is brought into contact with the electrostatic latent image carrier at the time of transfer, the toner image formed on the electrostatic latent image carrier comes into press contact with the intermediate transfer medium in transferring the toner image onto the intermediate transfer medium, and partial transfer failure occurs.

Also, if the transfer from the electrostatic latent image carrier to the intermediate transfer body is incomplete so that the toner remains on the surface of the electrostatic latent image carrier, the residual toner passes between the conductive elastic roller coming into press contact with the electrostatic latent image carrier and a nip. And, if the residual toner is present between the electrostatic latent image carrier and the conductive elastic roller, uniform charge on the surface of the electrostatic latent image carrier cannot be realized, and an electrostatic latent image of the electrostatic latent image carrier falls into disorder, resulting in causing image deficiency.

Pursuant to the requirement to realize a high image quality in the foregoing full color images, when the size of the toner becomes small, an adhesive force of the toner to the electrostatic latent image carrier becomes large in the transfer step as compared with a Coulomb force to be applied to the toner particles. As a result, the toner remaining after transfer (residual toner) increases, whereby charge failure of the electrostatic latent image carrier tended to accelerate.

For the purpose of preventing this charge failure of electrostatic latent image carrier, a cleaning measure is provided between a contact point of the electrostatic latent image carrier with the intermediate transfer medium and a contact point of the electrostatic latent image carrier with the conductive elastic roller. The foregoing residual toner is strongly fixed onto the surface of the electrostatic latent image carrier as a result of press contact in passing between the electrostatic latent image carrier and the intermediate transfer body.

As a cleaning method of removing the foregoing fixed residual toner from the electrostatic latent image carrier, a blade cleaning method of achieving the removal by strongly pressing an elastic blade to the electrostatic latent image carrier is considered suitable from the viewpoint of a cleaning ability and generally employed. However, in this system, since the elastic blade as well as the conductive elastic roller and the intermediate transfer body are strongly pressed to the electrostatic latent image carrier, abrasion caused by deterioration of the surface of the electrostatic latent image carrier is liable to occur, leading to a problem against a long life.

On the other hand, there is also proposed a method of cleaning the electrostatic latent image carrier by pressing a brush in place of the elastic blade to the electrostatic latent image carrier under a weak pressure. The cleaning method using a brush is effective in view of suppression of deterioration of the surface of the electrostatic latent image. However, this cleaning method using a brush involved such problems that a toner captured amount is little so that the method is difficult in application to the case of low transfer efficiency as compared with that in the cleaning method using an elastic blade and that a capture force of the fixed residual toner is weak as compared with that in the cleaning method using an elastic blade.

Also, when the step of transfer from the electrostatic latent image carrier to the intermediate transfer body is defined as primary transfer and the step of transfer from the intermediate transfer body to the recording medium is defined as secondary transfer, the transfer is repeated twice. Therefore, a technique for enhancing the transfer efficiency becomes important more and more. In particular, in the case of secondary transfer, multi-color images are transferred at a time, and the recording medium changes in various ways (for example, in the case of paper, its thickness and surface properties, etc.). Accordingly, for the sake of reducing the influence, it is required to control the transfer properties at an extremely high level. However, it has been confirmed that if a change of the fine structure of the toner surface, especially embedding or peeling of an external additive, occurs due to the influence of a stress to be applied in the primary transfer, inconvenience of a lowering of the transfer properties in the secondary transfer occurs.

For the foregoing reasons, toners to be used in such image forming methods are required to have high transfer efficacy, toner structure-keeping characteristics against a stress, and easiness of removal of a residual toner in brush cleaning.

As a measure for enhancing the toner transfer efficiency, it is proposed to make the shape of a fine powder part of toner closed to the sphere (for example, see JP-A-62-184469). Also, it is proposed to improve the cleaning properties by a cleaning blade by defining the average particle size and average circularity of a spherical toner and the heterogeneous circularity content; and a developer taking into overall consideration the transfer efficiency by defining the particle size and particle size distribution of toner and the average circularity and circularity distribution of toner is proposed (for example, see JP-A-11-344829 and JP-A-11-295931).

These proposals are concerned with an invention for enhancing the transfer efficiency by making the average shape/shape distribution of toner closed to the sphere. However, only by the average shape/shape distribution of toner, the surface fine irregular structure of the toner surface could not be specified so that it is impossible to stably keep the transfer efficiency high. That is, even in toners exhibiting the same average shape/shape distribution, there is encountered such a problem that the transfer efficiency (especially maintenance of transfer efficiency) varies depending upon a difference of the fine irregular structure of the toner surface and uneven distribution of an external additive occurred due to a difference of the surface fine irregular structure.

### SUMMARY OF THE INVENTION

The present invention has been made in view of the above circumstances and provides a toner for use in the development of electrostatic latent images which is satisfied with toner transfer properties over a long period of time and an electrostatic latent image developer using the same.

### Means for Solving the Problems

The present inventors made extensive and intensive investigations. As a result, it has been found that the foregoing problem can be solved by controlling a surface roughness (arithmetic average height) and surface roughness distribution of toner, leading to accomplishment of the invention as described below.

According to a first aspect of the invention, a toner has an average circularity of 0.975 or more, a median of arithmetic average height distribution of from 0.05 μm to 0.12 μm, and a fluctuation of arithmetic average height of 35 or less, in which the circularity is defined by:

[Circularity]=[Peripheral length of equivalent circle diameter]/[Peripheral length]=[2×(Aπ)^{1/2}]/PM

where A represents a projected area of a particle and PM represents a peripheral length of a particle.

By using the toner according to the first aspect of the invention, uneven distribution of the external additive occurred due to a difference of the surface fine irregular structure are able to be suppressed. Further, by suppressing a scatter of the adhesion amount/adhesion state of the external additive on the toner surface, uniform charge of the toner and revealment of a uniform spacer effect of the external additive are realized. Thus, initial transfer efficiency and transfer efficiency after use over a long period of time are able to be enhanced.

According to a second aspect of the invention, an image forming method includes forming an electrostatic latent image on an electrostatic charge image carrier; developing the electrostatic latent image on the electrostatic charge image carrier by an electrostatic charge developer containing a toner to form a toner image; transferring the toner image to a recording medium; and fixing the toner image, in which an average circularity of the toner is 0.975 or more, a median of arithmetic average height distribution of the toner is in a range of from 0.05 μm to 0.12 μm, and a fluctuation of arithmetic average height of the toner is 35 or less, a fluctuation of arithmetic average height of the toner is 35 or less, and the circularity is defined by

[Circularity]=[Peripheral length of equivalent circle diameter]/[Peripheral length]=[2×(Aπ) ^{1/2}]/PM

where A represents a projected area of a particle and PM represents a peripheral length of a particle.

According to the invention, it is possible to provide a toner for use in the development of electrostatic latent images, which can keep well the toner transfer properties over a long period of time, and in particular, in the case of recovering a residual toner on the surface of an electrostatic latent image carrier using an electrostatic brush without using a blade cleaning step accelerating abrasion of the electrostatic latent image carrier, can be improved in adhesion of the toner to a photoreceptor, and an electrostatic latent developer. Also, according to the invention, it is possible to provide an image forming method capable of performing development, transfer and fixing corresponding to requirements of high image quality.

### DETAILED DESCRIPTION OF THE PROFFERED EMBODIMENTS

The invention will be described below in detail.

### <Toner for Use in the Development of Electrostatic Latent Images>

The toner for use in the development of electrostatic latent images of the invention (hereinafter sometimes simply referred to as “toner”) is a toner for use in the development of electrostatic latent images comprising colored particles containing at least a binder resin, a coloring agent and a releasing agent, and an external additive, wherein an average circularity of the toner is 0.975 or more; a median of arithmetic average height distribution of the toner is 0.05 μm or more and not more than 0.12 μm (also described as “from 0.05 to 0.12 μm, hereinafter the same); and a fluctuation of arithmetic average height is not more than 35.

The toner for use in the development of electrostatic latent images of the invention contains colored particles containing at least a binder resin, a coloring agent and a releasing agent, and an external additive and further contains other components, if desired. Details of these components will be described later.

The toner of the invention has an average circularity of 0.975 or more, and preferably 0.980 or more. Also, the toner preferably has a fluctuation of circularity of not more than 0.25, and more preferably not more than 0.20.

The “average circularity” as referred to herein is a value obtained by subjecting the certain number of toners to image analysis, determining a circularity of each of the photographed toners according to the following expression and averaging the determined circularities. Also, the fluctuation of circularity as referred to herein is a value obtained by subjecting the thus determined respective circularities to statistical processing and expressing a standard deviation from an average value thereof in terms of percentage.

[Circularity]=[Peripheral length of equivalent circle diameter]/[Peripheral length][2×(Aπ)^{1/2}]/PM

In the expression, A represents a projected area of a particle; and PM represents a peripheral length of a particle

With respect to the foregoing average circularity, the case where it is 1.0 is that the toner is a true sphere; and the lower the numerical value, the larger the heterogeneity to show the presence of irregularities in the outer periphery. In the case where the average circularity is less than 0.975, the homogeneity of the toner becomes large, and the surface area becomes large. When the surface area becomes large, an electrostatic adhesive force increases, and the transfer efficiency is extremely lowered. Also, when the homogeneity is large, the external additive is embedded into concaves of the toner surface, whereby the functions of the external additive (charge impartation/spacer effect) are substantially lowered. Because of these influences, it becomes difficult to attain high transfer efficiency.

Also, when the foregoing fluctuation of circularity falls within the foregoing range, the distribution of the toner shape does not become large, and the adhesion state of the external additive for every toner becomes uniform. When the adhesion state of the external additive is uniform, the charge amount becomes uniform so that it is possible to transfer toners under a single transfer condition at the same time and with very high efficiency.

Also, the toner of the invention has a median of arithmetic average height distribution of 0.05 μm or more and not more than 0.12 μm and a fluctuation of arithmetic average height of not more than 35.

The arithmetic average height of toner as referred to herein is an index of surface roughness and is a physical amount generally expressed as “Ra”.

The Ra is a value obtained by taking out a standard length in the average line direction from a toner surface roughness curve and summing up absolute values of deviations from the average line of the taken-out part to the measured curve and averaging them. When this value is small, the surface becomes in a smooth state; and when the value is large, the surface becomes in a rough state.

The arithmetic average height of toner can be determined by using a plural number of toners as a sample, exposing the surfaces of these particles with laser beams and analyzing the fine irregular structure of the sample surface from analysis of the reflected light. For example, for the sake of achieving this analysis, a super-depth color 3-D shape measuring microscope VK-9500, manufactured by Keyence Corporation can be used. This device exposes the sample with laser and performs three-dimensional scanning. The laser reflected light is monitored at every position using a CCD camera, to obtain three-dimensional surface information of the sample. The resulting surface information is statistically processed, whereby various characteristic values regarding the surface roughness can be determined.

In the invention, the measurement is carried out with respect to 1,000 toners, and the arithmetic average height distribution of toner is determined by statistic processing of the data, from which are then obtained data concerning an average value, a median and a standard deviation of the arithmetic average height. The fluctuation of arithmetic average height as referred to herein is a standard deviation of the arithmetic average height from the average value in terms of a percentage.

The median of arithmetic average height of the toner of the invention is from 0.05 to 0.12 μm. In the case where the median of arithmetic average height of the toner is less than 0.05 μm, since the surface fine irregular structure of the toner is small, the spacer effect of the external additive is small, and the transfer efficiency is lowered.

Also, in the case where the median of arithmetic average height of the toner is larger than 0.12 μm, the external additive is liable to be embedded in the roughness of the surface fine irregular structure of the toner, the spacer effect of the external additive cannot be effectively revealed, and the transfer efficiency is lowered.

Also, the fluctuation of arithmetic average height of the toner of the invention is not more than 35. The fluctuation of arithmetic average value as referred to herein expresses a distribution of arithmetic average height. When the fluctuation of arithmetic average value is small, the distribution becomes narrow. When the fluctuation of arithmetic average weight is larger than 35, since the irregular distribution of the surface roughness of the toner becomes large, the adhesion state of the external additive on the toner surface becomes non-uniform, the discharge distribution of every toner becomes scattered, and the transfer efficiency is lowered.

Further, it is preferable that a value of 90% accumulation of the arithmetic average height distribution of the toner of the invention is less than 0.15 μm. When this value falls within the foregoing range, the external additive is not much embedded in the irregularities of the surface, whereby the execute amount of the external additive can be kept. Also, since the external additive is not unevenly distributed, uniform charge of the toner and a uniform spacer effect of the external additive are revealed, and high transfer efficiency is liable to be realized.

Also, in order to realize such a toner structure, it is preferred to control the median of arithmetic average height of the colored particles at 0.03 μm or more and not more than 0.10 μm and to make at least one external additive having a median diameter as reduced into volume of 0.1m or more and less than 0.3 lam adhere to the colored particles. The median diameter as referred to herein is a 50% particle size of the cumulative particle size distribution curve.

When the median of arithmetic average height of the colored particles falls within the foregoing range, the surface of the colored particle is rough so that adhesion of the external additive is strong and that the adhesion state becomes stable. Therefore, such is preferable. Also, the external additive is not unevenly distributed in concaves of the colored particles, and a stable adhesion state of the external additive is obtained. Therefore, such is preferable.

When the median diameter as reduced into volume of the external additive falls within this range, it becomes easy to realize the arithmetic average height of the toner of 0.05 μm or more and not more than 0.12 μm, an aspect of which is a characteristic feature of the invention, and therefore, such is preferable.

The toner of the invention preferably has a number average particle size DTN in the range of from 5.0 to 7.0 μm, and more preferably in the range of from 5.5 to 6.5 μm. When the number average particle size DTN of the toner falls within this range, the surface area of the toner does not become large, and the electrostatic adhesive force does not increase so that the transfer efficiency is not lowered. Therefore, such is preferable. Also, in the development step and transfer step, since the toner hardly flies out, reproducibility of electrostatic latent images is not lowered, and high-grade image quality is obtained. Therefore, such is preferable.

Incidentally, what the number average particle size falls within the foregoing range is also preferable in view of the matter that color reproducibility is excellent in the full color image formation.

Also, the toner of the invention preferably has a fluctuation of number average particle size of not more than 25, and more preferably not more than 20. When the fluctuation of number average particle size is too large, a difference in size between the small size colored particles and the large size colored particles becomes large. Because of this difference in size, a difference of the surface area per toner becomes large. Since the surface charge density of the toner in a developing unit is corresponding to the foregoing surface area, the foregoing difference of the surface area per toner will appear as a difference of the charge amount per toner.

Accordingly, when the fluctuation of number average particle size falls within the foregoing range, the difference of the charge amount per toner does not become large, and therefore, such is preferable. If the difference of the charge amount is little, an optimum transfer electric field of every toner does not differ, and it is possible to transfer toners under a single transfer condition at the same time and with very high efficiency. Therefore, such is preferable.

Incidentally, the fluctuation of number average particle size as referred to herein is a value obtained by subjecting measured values of the number average particle size DTN regarding the certain number of toners to statistical processing and expressing a standard deviation from an average value thereof in terms of percentage. A specific measurement method will be described later.

The foregoing number average particle size, fluctuation of number average particle size, average circularity and fluctuation of circularity of toner are determined by subjecting each of at least 5,000 toners to image analysis using a flow particle image analyzer FPIA-2100 (manufactured by Sysmex Corporation) and then to statistic processing.

Next, the method of producing colored particles to be used in the invention will be described.

The colored particles to be used in the invention can be prepared by known kneading and pulverization production methods or chemical production methods such emulsion polymerization and suspension polymerization. In the invention, it is preferred to produce toners by the emulsion polymerization method in view of the matter that toners having excellent particle size distribution and shape distribution can be prepared and from the viewpoints of yield and circumferential load. The production method using the emulsion polymerization method will be described below in detail.

In the emulsion polymerization method, a dispersion of a binder resin with an ionic surfactant and a coloring agent dispersed in an ionic surfactant having an opposite polarity are mixed to cause hetero-coagulation, thereby forming coagulated particles of toner (coagulation step). Thereafter, the coagulated particles are fused and integrated by heating at a temperature of the glass transition point of the foregoing resin or higher (fusion step), followed by washing and drying to produce a toner.

According to this method, by choosing the heating temperature condition and the like, not only it is possible to control the toner shape from an amorphous form to spherical form, but also it is possible to control the arithmetic average height of the colored particles. Even when the colored particles and the binder resin particles have the same polarity, it is possible to form similar coagulated particles by adding a surfactant having an opposite polarity. Further, by employing a method in which prior to heating the foregoing dispersion of coagulated particles to fuse the coagulated particles, another dispersion of particles (adhered particles) is added and mixed, thereby making the particles adhere to the surfaces of the original coagulated particles, and the resulting particles are fused by heating at a temperature of the glass transition point of the resin or higher, it is possible to control the layer structure extending from the toner surface to the inside thereof. Further, by this method, it is possible to coat the toner surface with the binder resin, to coat the toner surface with an charge controling agent, or to align the releasing agent and coloring agent particles in the vicinity of the toner surface.

At this time, in controlling the particle size distribution and shape distribution and the arithmetic average height, it is important that the particles (adhered particles) of the particle dispersion to be added and mixed later adhere uniformly and steadily onto the surfaces of the coagulated particles. If the particles to be made to adhere are present in the liberated state, or the particles which have adhered once are again liberated, the particle size distribution or shape distribution becomes easily broad, and the arithmetic average height also changes. If the particle size distribution becomes broad, in particular, in the case where the toner particles are a finely divided powder, the toner particles strongly adhere to the photoreceptor at the time of development, causing formation of black spots; and in a two-component system developer, staining of the carrier is liable to be caused, resulting in shortening the life of the developer. Also, in a one-component system developer, the developer is fixed to a development roller, a charge roller, a trimming roller, or a blade and stains it, causing a factor of lowering the image quality. Further, a problem of the particle size distribution in the toner is a large factor relative to a lowering of the image quality and reliability.

Also, in the case of producing a toner by the foregoing emulsion polymerization coagulation method, it is important to control the stirring condition for the particle size distribution and shape distribution. At the time of forming coagulated particles which will become a matrix or after adding the adhered particles, the viscosity of the dispersion increases. Thus, for the purpose of achieving uniform mixing, if the dispersion is stirred at a high shear rate using a stirring blade such as a tilted paddle type stirring blade, adhesion of the coagulated particles to the reactor wall or stirring blade increases, whereby homogeneity of the particle size is hindered. In order to achieve uniform stirring at a low shear rate, it is effective to use a stirring blade having a blade shape such that the width in the liquid depth direction is broad (flat blade stirrer).

In addition, after forming the coagulated particles, by filtration using a filter bag having an opening of 10 μm coarse powders can be effectively removed. If desired, multi-plate or repeated treatment is also effective. When the average particle size of the toner is small, or the toner shape is closed to a sphere, the influence of the particle size distribution or shape distribution against the image quality becomes large.

In general, in the coagulation fusion process, since the particles are collectively mixed and coagulated, the coagulated particles can be fused in a uniform mixing state, and the toner formulation becomes uniform from the surface to the inside. In the case where the releasing agent is contained according to the foregoing method, the releasing agent is present on the surface after fusion, whereby a phenomenon such as embedding of the external additive in the inside of the toner due to generation of filming or impartation of fluidity is liable to occur.

Then, in the coagulation step, it is possible to add a dispersion of particles (adhered particles) treated with surfactants having a polarity and an amount such that a balance of the amounts of ionic surfactants having a respective initial polarity is deviated in advance, matrix coagulated particles of the first stage are formed at a temperature of not higher than the glass transition point and stabilized, and the deviation is supplemented at the second stage. Further, if desired, by stabilizing the particles by slightly heating at a temperature of not higher than the glass transition point of the resin contained in the foregoing matrix coagulated particles or supplemented particles and then heating at a temperature of the glass transition point or higher, fusion can be achieved in the state that the particles added at the second stage adhere onto the surfaces of the matrix coagulated particles. These coagulation operations can be carried out repeatedly in a stepwise manner. As a result, it is possible to change the formulation and physical properties in a stepwise manner from the surface to the inside of the toner particle, whereby it becomes extremely easy to control the toner structure.

For example, in the case of color toners to be used in multi-color development, by preparing matrix coagulation particles from particles of the binder resin and particles of the coloring agent at the first stage and then adding a dispersion of particles of another binder resin to form only a resin layer on the toner surface, it is possible to minimize the influence of particles of the coloring agent against the charge behavior. As a result, it is possible to suppress a difference of the charge characteristics caused depending upon the kind of coloring agent. Also, by setting up the glass transition point of the binder resin to be added at the second stage at a high level, it is possible to coat the toner in a capsule state. Thus, it is possible to make heat storage properties cope with fixing properties.

In addition, by adding a dispersion of particles of the releasing agent such as waxes at the second stage and further forming a shell on the outermost surface using a dispersion of a resin having a high hardness at the third stage, not only it is possible to suppress exposure of the wax onto the toner surface from occurring, but also it is possible to make the wax work effectively as the releasing agent at the time of fixing.

Also, after containing particles of the releasing agent in the matrix coagulated particles, a shell may be formed on the outermost surface at the second stage, thereby preventing exposure of the wax from occurring. When the exposure of the wax is prevented, not only filming to the photoreceptor, etc. can be suppressed, but also powder fluidity of the toner can be enhanced.

In this way, in a method in which particles (such as particles of the binder resin and particles of the releasing agent) are made to adhere onto the surfaces of the coagulated particles in a stepwise manner and heat fused, maintenance of the particle size distribution or shape distribution and fluctuation of the average particle size or circularity can be suppressed. Also, it is possible to make the addition of stabilizers for enhancing stability of the coagulated particles (for example, surfactants, bases, and acids) unnecessary, or to minimize the addition amounts thereof.

It is desired that the dispersion size of the dispersed particles is not more than 1 μm in all of the case of using them as the matrix coagulated particles or as the supplemental particles. When the dispersion size falls within the foregoing range, the particle size distribution of the toner as ultimately formed is narrow, liberated particles are not generated, and the performance or reliability of the toner is enhanced. Therefore, such is preferable.

The amount of the dispersion of particles to be supplemented depends upon the volumetric fraction of the matrix coagulated particles to be contained. It is desired to adjust the amount of the dispersion of particles to be supplemented within 50% (as reduced into volume) of the coagulated particles as ultimately formed. When the amount of the dispersion of particles to be supplemented falls within 50%, the particles to be supplemented adhere to the matrix coagulated particles and do not form separately new coagulated particles. Therefore, such is preferable. Also, such is preferable in view of the matter that the distribution of formulation or the distribution of particle size can be made narrow, thereby obtaining a desired performance.

What the supplementation of a dispersion of particles is dividedly carried out in a stepwise manner or continuously carried out step-by-step is effective for suppressing the generation of new coagulated particles and making the particle size distribution or shape distribution sharp. Further, when the dispersion of particles is supplemented, by heating at a temperature of not higher than the glass transition temperature of the resin of the matrix coagulated particles and the supplemental particles, and preferably from a temperature of 40 ° C. lower than the glass transition temperature to the glass transition temperature, it is possible to suppress the generation of liberated particles.

Examples of thermoplastic binder resins that are used as the binder resin in the toner of the invention include polymers of monomers [such as styrenes (for example, styrene, p-chlorostyrene, and α-methylstyrene), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl meth-acrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene)], copolymers comprising a combination of two or more kinds of these monomers, and mixtures thereof; and non-vinyl condensation system resins (such as epoxy resins, polyester resins, polyurethane resins, polyamide resins, cellulose resins, and polyether resins), mixtures thereof with the foregoing vinyl based resins, and graft polymers obtained by polymerizing a vinyl based monomer in the coexistence thereof. These resins may be used singly or in combinations of two or more kinds thereof.

Above all, when an ethylenically unsaturated monomer is used, a dispersion of resin particles can be prepared by carrying out emulsion polymerization or seed polymerization using an ionic surfactant, etc. As other methods of preparing a dispersion of resin particles, there can be enumerated a method in which when an oil-soluble resin is used, the resin is dissolved in an oily solvent having a relatively low solubility in water, particles are dispersed in water in the coexistence of an ionic surfactant or a high-molecular electrolyte using a dispersion machine such as a homogenizer, and the solvent is then evaporated off upon heating or in vacuo.

The foregoing thermoplastic binder resin can stabilize particles obtained by emulsion polymerization or the like by compounding a dissociative ethylenically unsaturated monomer. As the dissociative ethylenically unsaturated monomer, any ethylenically unsaturated monomers which can be a staring material of high-molecular acids or high-molecular bases, such as acrylic acid, methacrylic acid, maleic acid, cinnamic acid, fumaric acid, vinylsulfonic acid, ethyleneimine, vinylpyridine, and vinylamine, can be used. Of these, ethylenically unsaturated acids are preferable in view of easiness of polymer forming reaction. Further, dissociative ethylenically unsaturated monomers having a carboxyl group, such as acrylic acid, methacrylic acid, maleic acid, cinnamic acid, and fumaric acid, are especially effective for controlling the polymerization degree and controlling the glass transition point.

The binder resin particles preferably have an average particle size of not more than 1 μm, and more preferably in the range of from 0.01 to 1 μm. When the average particle size of the binder resin particles falls within the foregoing range, there give rise to advantages such that uneven distribution among the toners is reduced; dispersion in the toner becomes good; and a scattering in the performance and reliability becomes small. Incidentally, the average particle size of the binder resin particles can be, for example, measured using Microtrac, etc.

In the invention, examples of the releasing agent that can be used include low-molecular weight polyolefins such as polyethylene, polypropylene, and polybutene; silicones having a softening point upon heating; fatty acid amides such as oleic amide, erucic amide, ricinoleic acid amide, and stearic acid amide; vegetable waxes such as ester wax, carnauba wax, rice wax, candelilla wax, haze wax, and jojoba oil; animal waxes such as bees wax; minerals such as montan wax, ozokerite, ceresin, paraffin wax, microcrystalline wax, and Fischer-Tropsch wax; petroleum waxes; and modified products thereof. By dispersing such a wax in water together with an ionic surfactant and a high-molecular electrolyte such as high-molecular acids and high-molecular bases and finely dividing the dispersion by heating at a temperature of the melting point or higher using a homogenizer or pressure discharge type dispersion machine capable of imparting a strong shear force, a dispersion of particles of not more than 1 μm can be prepared.

The releasing agent particles preferably have an average particle size of not more than 1 μm, and more preferably in the range of from 0.01 to 1 μm. When the average particle size of the releasing agent particles falls within the foregoing range, there give rise to advantages such that uneven distribution among the toners is reduced; dispersion in the toner becomes good; and a scattering in the performance and reliability becomes small. Incidentally, the foregoing average particle size can be, for example, measured using Microtrac, etc.

In the invention, as the coloring agent, various pigments. (such as carbon black, Chrome Yellow, Hansa Yellow, Benzidine Yellow, Threne yellow, Quinoline Yellow, Permanent Orange GTR, Pyrazolone Orange, Vulcan Orange, Watchyoung Red, Permanent Red, Brilliant Carmine 3B, Brilliant Carmine 6B, Du Pont Oil Red, Pyrazolone Red, Lithol Red, Rhodamine B Lake, Lake Red C, Rose Bengale, Aniline Blue, Ultramarine Blue, Chalco Oil Blue, Methylene Blue Chloride, Phthalocyanine Blue, Phthalocyanine Green, and Malachite Green Oxalate) and various dyes (such as acridine based dyes, xanthene based dyes, azo based dyes, benzoquinone based dyes, azine based dyes, anthraquinone based dyes, thioindigo based dyes, dioxazine based dyes, thiazine based dyes, azomethine based dyes, indigo based dyes, phthalocyanine based dyes, aniline black based dyes, polymethine based dyes, triphenylmethane based dyes, diphenylmethane based dyes, and thiazole based dyes) can be used singly or in admixture of two or more kinds thereof.

In the invention, the coloring agent particles preferably have a volume average particle size of not more than 0.8 μm, and more preferably in the range of from 0.05 to 0.5 μm. When the average particle size of the coloring agent particles falls within the foregoing range, the particle size distribution or shape distribution of the ultimately obtained toner for use in the development of electrostatic latent images falls within a proper range, liberated particles are hardly generated, and uneven distribution of the toner formulation does not occur, whereby the performance and reliability become good. Therefore, such is preferable. Also, the coloring properties and the shape controlling properties as one of characteristic features of the emulsion coagulation method become good, whereby a toner having a shape closed to pearl is liable to be obtained. Therefore, such is preferable.

Also, if desired, a charge controling agent can be used. As the charge controling agent, various charge controling agents that are usually used, such as dyes composed of a quaternary ammonium salt, a nigrosine based compound, or a complex of aluminum, iron, chromium, etc. and triphenylmethane based pigments can be used. For the purpose of controlling the ionic strength affecting coagulation or stability at the time of fusion integration and reducing contamination of water, charge controling agents that are hardly dissolved in water are suitable.

Examples of surfactants which are used in emulsion polymerization, seed polymerization, dispersion of the coloring agent, and dispersion, coagulation or stabilization of the binder resin particles and releasing agent, etc. include anionic surfactants such as sulfuric ester based surfactants, sulfonated based surfactants, phosphoric ester based surfactants, and soap based surfactants; cationic surfactants such as amine salt based surfactants and quaternary ammonium salt based surfactants; and nonionic surfactants such as polyethylene glycol based surfactants, alkylphenol ethylene oxide adduct based surfactants, and polyhydric alcohol based surfactants. Combinations of different kinds of surfactants are also effective. As a dispersion measure, a rotary shear type homogenizer or general dispersion machines having a medium such as a ball mill, a sand mill, and a dyno mill can be used.

Also, in the case of using a composite comprising a binder resin and a coloring agent, there can be employed a method in which the binder resin and the coloring agent are dissolved and dispersed in a solvent, the dispersion is then dispersed in water together with the foregoing appropriate dispersant, and thereafter, the solvent is removed upon heating or in vacua to obtain the composite; and a method in which the composite is prepared by adsorption and fixing by mechanical shear or electrically on the surface of a latex prepared by emulsion polymerization or seed polymerization. These methods are effective in suppressing liberation of the coloring agent as supplemental particles and improving the dependency of chargeable coloring agent.

Examples of dispersion media in dispersions having dispersed therein the foregoing binder resin particle dispersion, coloring agent dispersion and releasing agent dispersion, etc. include aqueous media.

Examples of the foregoing aqueous media include water such as distilled water and ion-exchanged water and alcohols. These aqueous media can be used singly or in combinations of two or more kinds thereof.

In the invention, the dispersion having dispersed therein particles containing at least binder resin particles is prepared by adding and mixing the foregoing binder resin particle dispersion, coloring agent dispersion and releasing agent dispersion, etc. By heating the dispersion at a temperature in the range of from room temperature to the glass transition temperature of the binder resin, the binder resin particles, the coloring agent and the releasing agent are coagulated to form coagulated particles. The coagulated particles preferably have a number average particle size in the range of from 3 to 10

In the case of mixing the foregoing binder particle dispersion and the foregoing coloring agent dispersion, etc., the content of the foregoing binder resin particles may be not more than 40% by weight and is preferably in the range of from about 2 to 20% by weight. Also, the content of the foregoing coloring agent may be not more than 50% by weight and is preferably in the range of from about 2 to 40% by weight. Further, as the content of the foregoing other components (particles), one at which the object of the invention is not hindered may be employed. In general, the content is a very small amount, and concretely, it is in the range of from about 0.01 to 5% by weight, and preferably in the range of from about 0.5 to 2% by weight.

Next, if desired, after completion of the foregoing adhesion step, the mixed liquid containing the coagulated particles is heat treated at a temperature of the softening point of the resin or higher, and generally in the range of from 70 to 120 ° C., thereby fusing the coagulated particles. There can be thus obtained a liquid containing the colored particles. It is possible to control the arithmetic average height of toner depending upon the condition of this heat treatment. When the heat treatment temperature is high, the toner surface becomes smooth so that the arithmetic average height can be made small. Conversely, when the heat treatment temperature is low, the irregularities of the toner surface become large so that the arithmetic average height can be made large.

The obtained colored particle dispersion is subjected to centrifugation or suction filtration to separate the toner particles, which are then washed once to thrice with ion-exchanged water. Thereafter, the colored particles are filtered out and washed once to thrice with ion-exchanged water, followed by drying. There can be thus obtained the colored particles that are used in the invention.

Next, the external additive to be used in the invention will be described below.

In the colored particles in the invention, it is preferred to use at least one external additive having a median diameter of 0.1 μm or more and less than 0.3μm. By using such an external additive, it is possible to relieve a stress to be applied to the toner and to keep high transfer efficiency.

As the external additive having a median diameter of 0.1 μm or more and less than 0.3 μm, monodispersed spherical particles can be used, and monodispersed spherical silica or monodispersed spherical organic resin particle external additives are preferable. Of these, monodispersed spherical organic resin particle external additives are more preferable. In the invention, as the definition of the monodispersion, discussion can be made with respect to a standard deviation against the average particle size including a coagulant of the external additive. The case where a fluctuation coefficient (a rate of the arithmetic standard deviation to the arithmetic average particle size) is not more than 40% is defined such that the dispersion is monodispersed. The deviation coefficient is preferably not more than 30%. This deviation coefficient can be determined by a laser diffraction/scattering type particle size distribution analyzer.

The monodispersed spherical silica can be obtained by the sol-gel method as a wet method. The particle size of the monodispersed spherical silica can be freely controlled by hydrolysis of the sol-gel method, weight ratios of alkoxysilane, ammonia, alcohol and water of the polycondensation step, reaction temperature, stirring rate, and feed rate. The monodispersion and spherical shape can be achieved by preparation by this measure.

Concretely, tetramethoxysilane is dropped and stirred in the presence of water and an alcohol while applying temperature using ammonia water as a catalyst. Next, the silica sol suspension obtained by the reaction is subjected to centrifugation to separate into the wetted silica gel, alcohol and ammonia water, respectively. A solvent is added to the wetted silica gel to make it again in the silica sol state, to which is then added a hydrophobilizing agent, thereby making the silica surface hydrophobic. As the hydrophobilizing agent, general silane compounds can be used. Next, the solvent is removed from the hydrophobilized silica sol, and the residue is dried and sieved. There can be thus obtained the desired monodispersed spherical silica. Also, the thus obtained silica may be again subjected to the treatment. The production method of the monodispersed spherical silica is not limited to the foregoing production method.

As the foregoing silane compound, ones which are soluble in water can be used. As such a silane compound, a compound represented by the chemical structural formula, RₐSiX₄₋ₐ (wherein a represents an integer of from 0 to 3; R represents a hydrogen atom or an organic group such as an alkyl group and an alkenyl group; and X represents a chlorine atom or a hydrolyzable group such as a methoxy group and an ethoxy group) can be used, and any types of chlorosilanes, alkoxysilanes, silazanes, and special silylating agents can be used.

Specifically, representative examples thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, isobutyltrimethoxysilane, decyltrimethoxysilane, hexamethyldisilazane, N,O-(bistrimethylsily)acetamide, N,N-bis(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxy-propyltrimethoxysilane, γ-glycidoxypropylmethyldiethoxysilane, γ-mercaptopropyltrimethoxysilane, and γ-chloropropyltrimethoxysilane. In the invention, dimethyldimethoxysilane, hexamethyldisilazane, methyltrimethoxysilane, isobutyltrimethoxysilane, and decyltrimethoxysilane are especially preferable as the hydrophobilizing agent.

The addition amount of the foregoing monodispersed spherical silica is preferably in the range of from 0.5 to 5 parts by weight, and more preferably in the range of from 1 to 3 parts by weight based on 100 parts by weight of the colored particles. When the addition amount of the monodispersed spherical silica is less than 0.5 parts by weight, an effect for reducing a non-electrostatic adhesive force is so low that sufficient effects for enhancing the development and transfer may not be obtained. On the other hand, when the addition amount of the monodispersed spherical silica is more than 5 parts by weight, this amount exceeds an amount necessary for coating one layer on the colored particle surface, and the coating becomes in an excessive state. Thus, the silica moves into the contact member, whereby a secondary obstruction is liable to be caused.

Next, the monodispersed spherical organic resin particles that are preferably used as an external additive in the invention will be described below.

In the invention, for the sake of obtaining a necessary hardness required in the external additive, the monodispersed spherical organic resin particles preferably have a gel fraction of 90% by weight or more, and more preferably 95% by weight or more. The gel fraction as referred to herein is a weight proportion of non-dissolved matters in an organic solvent (tetrahydrofuran) and can be determined according to the following expression.

[Gel fraction (% by weight)]=[(Weight of non-dissolved matters in organic solvent)/(Weight of sample)]×100

The foregoing gel fraction is in a correlation with the degree of crosslinking or hardness of the resin. When the foregoing gel fraction is less than 90% by weight, in the case where the toner having the monodispersed spherical organic resin particles added thereto and the carrier are mixed in a prescribed ratio to form an electrostatic latent image developer (hereinafter sometimes simply referred to as “developer”), and the developer is set in a developing unit of a copy machine and repeatedly used, a spacer effect by the monodispersed spherical organic resin particles is exhibited at the initial stage, thereby revealing good development and transfer properties. However, the shape of the monodispersed spherical resin particle is gradually deformed from a spherical form to a flat shape with a time due to a stress to be applied to the toner within the developing unit, the sufficient spacer effect is lost, and the development and transfer properties are deteriorated.

Also, the reason why the external additive is limited to the monodispersed spherical organic resin particles resides in the matter that a refractive index of the monodispersed spherical organic resin particles is in the range of from 1.4 to 1.6 and that a refractive index of the colored particles is in substantially the same range as from 1.4 to 1.6. Since the refractive index is identical, light scattering at the interface between the colored particle and the monodispersed spherical organic resin particle external additive is small on the fixed image, and the color purity of full color images and the light permeability on OHP sheets are excellent.

The monodispersed spherical organic resin particles of the invention are, for example, obtained by drying an emulsion obtained by emulsion copolymerization of an aromatic ethylenically unsaturated monomer and a monomer having two or more ethylenically unsaturated groups in the molecule thereof in water or a dispersion medium containing water as the major component. The water to be used as the foregoing dispersion medium is preferably ion-exchanged water or pure water. Also, the dispersion medium containing water as the major component as referred to herein is a mixed aqueous solution of water and an organic solvent (for example, methanol), a surfactant, an emulsifier, a water-soluble high-molecular protective colloid (for example, polyvinyl alcohol), etc.

So far as achievement of the object of the invention is not hindered, the foregoing surfactant, emulsifier or protective colloid may be reactive or non-reactive. Also, such a surfactant, an emulsifier or a protective colloid may be used singly or in combinations with two or more kinds thereof.

Examples of reactive surfactants include anionic reactive surfactant or nonionic reactive surfactants into which a radical polymerizable propenyl group is introduced. These reactive surfactants may be used singly or in combinations of two or more kinds thereof.

Examples of the foregoing aromatic ethylenically unsaturated monomer that is used in the invention include styrene, α-methylstyrene, β-methylstyrene, o-methylstyrene, m-methylstyrene, p-methylstyrene, p-ethylstyrene, 2,4-dimethylstyrene, 2,5-dimethylstyrene, 3,4-dimethylstyrene, 3,5-dimethylstyrene, 2,4,5-trimethylstyrene, 2,4,6-trimethylstyrene, p-n-butylstyrene, p-t-butylstyrene, p-n-hexylstyrene, p-n-octylstyrene, p-n-dodecylstyrene, p-methoxystyrene, p-phenylstyrene, p-chlorostyrene, 3,4-dichlorostyrene, and potassium styrenesulfonate. Of these, styrene is suitably used. These aromatic ethylenically unsaturated monomers maybe used singly or in combinations of two or more kinds thereof.

Also, examples of the foregoing monomer having two or more ethylenically unsaturated groups in the molecule thereof (hereinafter abbreviated as “polyfunctional ethylenically unsaturated group-containing monomer”), which is used in the invention, include divinylbenzene, ethylene glycol di(meth)-acrylate, ethylene oxide di(meth)acrylate, tetraethylene oxide di(meth)acrylate, 1,6-hexanediol diacrylate, neopentyl glycol diacrylate, trimethylolpropane tri(meth)acrylate, tetramethylolmethane triacrylate, and tetramethylolpropane tetra(meth)acrylate. These polyfunctional ethylenically unsaturated group-containing monomers may be used singly or in combinations of two or more kinds thereof. Incidentally, the “(meth)acrylate” as referred to herein is “acrylate” or “methacrylate”.

The foregoing polyfunctional ethylenically unsaturated group-containing monomer functions as a crosslinking monomer and contributes to enhancement of a gel fraction of the resulting particles.

A copolymerization ratio of the foregoing polyfunctional ethylenically unsaturated group-containing monomer to the foregoing aromatic ethylenically unsaturated monomer is not particularly limited. The ratio of the polyfunctional ethylenically unsaturated group-containing monomer is preferably 0.5 parts by weight or more based on 100 parts by weight of the aromatic ethylenically unsaturated monomer. When the ratio of the polyfunctional ethylenically unsaturated group-containing monomer to the aromatic ethylenically unsaturated monomer falls within the foregoing range, the gel fraction of the resulting particles is sufficiently enhanced, and therefore, such is preferable.

In the invention, for the sake of causing and accelerating the emulsion copolymerization by radical polymerization reaction of the aromatic ethylenically unsaturated monomer and the polyfunctional ethylenically unsaturated group-containing monomer, a polymerization initiator may be used.

Examples of the foregoing polymerization initiator include aqueous hydrogen peroxide and persulfates such as ammonium persulfate, potassium persulfate, and sodium persulfate. These polymerization initiators may be used singly or in combinations of two or more kinds thereof.

The preparation method of the emulsion for obtaining the monodispersed spherical organic particles is not particularly limited and may be, for example, carried out according to the following procedures.

A reactor equipped with a stirrer, a nitrogen introducing pipe and a reflux condenser, such as a separable flask, is charged with a prescribed amount of each of water or a dispersion medium containing water as the major component, an aromatic ethylenically unsaturated monomer, and a polyfunctional ethylenically unsaturated group-containing monomer; and after raising the temperature to about 70 ° C. in a certain stirring state under an inert gas stream such as nitrogen, a polymerization initiator is added to initiate emulsion copolymerization by radical polymerization reaction. Thereafter, the emulsion copolymerization is completed within about 24 hours while keeping the temperature of the reaction system at about 70 ° C., whereby the desired emulsion can be obtained.

For the purpose of adjusting the pH, hydrochloric acid, acetic acid or other acid, or an alkali such as sodium hydroxide maybe thrown into the emulsion after completion of the polymerization. Next, by drying the resulting emulsion by a drying method such as a freeze drying method and a spray drying method, the monodispersed spherical organic particles to be used in the invention can be obtained.

In the toner for use in the development of electrostatic latent images of the invention, a combination of the foregoing monodispersed spherical silica and the foregoing monodispersed spherical organic particles can be used as the external additive. Also, a small particle size inorganic compound whose particle size distribution does not show monodispersion can be used together with the foregoing monodispersed spherical organic particles. As the small particle size inorganic compound whose particle size distribution does not show monodispersion, known compounds can be used. Examples thereof include silica, alumina, titania, calcium carbonate, magnesium carbonate, calcium phosphate, and cerium oxide. Also, the surfaces of these inorganic particles may be subjected to a known surface treatment depending upon the purpose.

Above all, metatitanic acid TiO(OH)₂ can provide a developer which does not affect the transparency and has good charge properties, environmental stability, fluidity and anti-caking properties, stable negative charge properties, and excellent stable image quality maintenance. Also, what a compound hydrophobilized with metatitanic acid has an electric resistance of 10¹⁰ Ω·cm or more is preferable in the case where it is used as the colored particle-treated toner because even when a transfer electric field is increased, high transfer properties are obtained without generating a toner having an opposite polarity.

The foregoing small particle size inorganic compound preferably has a number average particle size of not more than 80 nm, and more preferably not more than 50 nm.

In the invention, the foregoing external additive is added to and mixed with the colored particles. For example, the mixing can be carried out using known mixing machines such as a. V type blender, a Henschel mixer, and a Roedige mixer.

Also, in this case, a variety of additives may be added, if desired. Examples of the additives include other fluidizing agents and cleaning aids or transfer aids such as polystyrene particles, polymethyl methacrylate particles, and polyvinylidene fluoride particles.

In the invention, the adhesion state of the foregoing inorganic compound (such as a compound hydrophobilized with metatitanic acid) onto the colored particle surface may be a mere mechanical adhesion state or a state that the inorganic compound is lightly fixed onto the colored particle surface. Also, the inorganic compound may be coated entirely or partially on the colored particle surface. The addition amount of the foregoing inorganic compound is preferably in the range of from 0.3 to 3 parts by weight, and more preferably in the range of from 0.5 to 2 parts by weight based on 100 parts by weight of the colored particles. When the addition amount of the inorganic compound is less than 0.3 parts by weight, the fluidity of the toner may not be sufficiently obtained, and suppression of blocking due to the storage under heat is liable to become insufficient. On the other hand, when it exceeds 3 parts by weight, the coating state becomes excessive so that the excessive inorganic compound moves into the contact member, whereby a secondary obstruction is liable to be caused. Also, a screening process maybe employed without any problem after external addition and mixing.

The toner for use in the development of electrostatic latent images of the invention can be suitably produced by the foregoing production methods. However, it should not be construed that the invention is limited to these production methods.

### <Electrostatic Latent Image Developer>

The electrostatic latent image developer of the invention is characterized by containing the foregoing toner for use in the development of electrostatic latent images of the invention and a carrier. In the foregoing toner for use in the development of electrostatic latent images, the foregoing monodispersed spherical silica and monodispersed spherical organic particles, etc. are preferably used. The toner for use in the development of electrostatic latent images may cause changes with a time, such as embedding and elimination, due to a stress with the carrier, thereby possibly making it difficult to keep the high transfer performance of the initial stage. In particular, in the case of colored particles having a large average circularity, since there is no escape zone of the external additive so that the stress is uniformly applied, such changes with a time likely occur. For the sake of reducing the stress due to the carrier to keep a high image quality, it is preferred to control a true specific gravity of the carrier and saturation magnetization.

The true specific gravity of the carrier is preferably in the range of from 3 to 4; and the saturation magnetization under a condition of 5 kOe (400 kA/m) is preferably 60 A·m²/kg or more. A small true specific gravity is predominant against the stress. However, when the true specific gravity is too small, a lowering of the magnetic force per carrier particle occurs, thereby generating scattering of the carrier into the electrostatic latent image carrier. In order that the both properties may be compatible with each other, when the true specific gravity is 3 or more, and the saturation magnetization of 60 A·m²/kg or more, it is possible to suppress scattering of the carrier with a low stress.

When the true specific gravity is less than 3, even if the saturation magnetization is 60 A·m²/kg or more, the scattering of the carrier may possibly occur. With respect to the stress to the toner, when the true specific gravity is not more than 4, it is possible to largely enhance the transfer characteristics. Accordingly, in the case of conventionally employed iron (true specific gravity: 7 to 8) or ferrite or magnetite (specific gravity: 4.5 to 5), the transfer maintenance may possibly become insufficient.

When the foregoing carrier is a resin-coated carrier in which a resin coating layer (a matrix resin layer) having a conductive material dispersed in a matrix resin is provided on the surface of a core material, even if peeling of the resin coating layer occurs, it is possible to reveal high image quality over a long period of time without largely changing the volume resistivity.

Examples of the foregoing matrix resin include polyethylene, polypropylene, polystyrene, polyacrylonitrile, polyvinyl acetate, polyvinyl alcohol, polyvinyl butyral, polyvinyl chloride, polyvinylcarbazole, polyvinyl ether, polyvinyl ketone, a vinyl chloride-vinyl acetate copolymer, a styrene-acrylic acid copolymer, a straight silicone resin comprising an organosiloxane bond or modifications thereof, fluorocarbon resins, polyesters, polyurethanes, polycarbonates, phenol resins, amino resins, melamine resins, benzoguanamine resins, urea resins, amide resins, and epoxy resins. However, it should not be construed that the matrix resin is limited thereto.

Examples of the foregoing conductive material include metals (for example, gold, silver, and copper), titanium oxide, zinc oxide, barium sulfate, aluminum borate, potassium titanate, tin oxide, and carbon black. However, it should not be construed that the conductive material is limited thereto. The content of the foregoing conductive material is preferably in the range of from 1 to 50 parts by weight, and more preferably in the range of from 3 to 20 parts by weight based on 100 parts by weight of the matrix resin.

Examples of the core material of the carrier include core materials composed singly of a magnetic powder and core materials prepared by finely dividing a magnetic powder and dispersing it in a resin. Examples of the method of finely dividing a magnetic powder and dispersing it in a resin include a method of kneading a resin and a magnetic powder and pulverizing the kneaded mixture; a method of melting a resin and a magnetic powder and spray drying the melt; and a method of polymerizing a magnetic powder-containing resin in a solution using a polymerization production process. Use of a core material of the magnetic powder dispersion type by a polymerization production process is preferable because of a high degree of freedom from the viewpoints of controlling the true specific gravity of carrier and controlling the shape. What the foregoing carrier contains 80% by weight or more of a magnetic powder of particles based on the total weight of the carrier is preferable in view of the matter that scattering of the carrier hardly occurs. Examples of the foregoing magnetic material (magnetic powder) include magnetic metals such as iron, nickel, and cobalt and magnetic oxides such as ferrite and magnetite. The core material generally has a volume average particle size in the range of from 10 to 500 μm, and preferably in the range of from 25 to 80 μm.

Examples of the method of forming the foregoing resin coating layer on the surface of a carrier core material include a dipping process of dipping a carrier core material in a solution for forming a coating layer containing the foregoing matrix resin, conductive material and solvent; a spraying process of spraying a solution for forming a coating layer onto the surface of a carrier core material; a fluidized bed process of spraying a solution for forming a coating layer in the state that a carrier core material is floated by fluidized air; and a kneader coater process of mixing a carrier core material with a solution for forming a coating layer in a kneader coater and removing the solvent.

The solvent to be used in the foregoing solution for forming a coating layer is not particularly limited so far as it can dissolve therein the foregoing matrix resin. Examples thereof include aromatic hydrocarbons such as toluene and xylene; ketones such as acetone and methyl ethyl ketone; and ethers such as tetrahydrofuran and dioxane. Also, the foregoing resin-coated layer usually has a average film thickness in the range of from 0.1 to 10 μm. In the invention, in order to reveal a stable volume resistivity of the carrier with a time, the average film thickness of the resin-coated layer is preferably in the range of from 0.5 to 3 μm.

In order to achieve the high image quality, the volume resistivity of the carrier to be used in the invention is preferably in the range of from 10⁶ to 10¹⁴ Ω·cm, and more preferably in the range of from 10⁸ to 10¹³ Ω·cm at the time of 1,000 V corresponding to lower and upper limits of the usual development contrast potential. When the volume resistivity of the carrier is less than 10⁶ Ω·cm, reproducibility of thin lines is worse, and toner fogging into the background is liable to occur due to injection of charges. On the other hand, when the volume resistivity of the carrier exceeds 10¹⁴ Ω·cm, reproduction of black solids and halftones become worse. Also, the amount of the carrier moving into the photoreceptor increases, whereby the photoreceptor is likely injured.

As the electrostatic latent image developer of the invention, it is preferable that the foregoing toner for use in the development of electrostatic latent images is mixed in an amount in the range of from 3 to 15 parts by weight based on 100 parts by weight of the foregoing carrier and prepared.

### (Image Forming Method)

The image forming method of the invention includes a step of forming an electrostatic latent image on an electrostatic charge image carrier; a step of developing the electrostatic latent image on the electrostatic charge image carrier by a toner-containing electrostatic charge developer to form a toner image; a step of transferring the toner image onto a recording medium; and a step of fixing the toner image. The respective steps themselves are a general step and are described in, for example, JP-A-56-40868 and JP-A-49-91231. Incidentally, the image forming method of the invention can be carried out using known image forming devices such as a copy machine and a facsimile machine.

The formation of an electrostatic latent image is to form an electrostatic latent image on an electrostatic latent image carrier, and the formation of a toner image is to form a toner image by developing the electrostatic latent image with a developer on a developer carrier. The transfer is to transfer the toner image onto a body to be transferred, and examples of the body to be transferred include fixing substrates such as paper and intermediate rolls. The fixing is to fix the toner image transferred onto a fixing substrate on the fixing substrate upon heating from a fixing member.

In fixing, the toner image on the fixing substrate is heat melted and fixed during a time of passing the fixing substrate such as paper between two fixing members. The fixing members are in the state of a roller or belt, at least one of which is installed with a heating device. As the fixing members, rollers or belts are used as they are, or those in which a resin is coated on the surface are used.

The fixing roller is prepared by coating silicone rubber, viton rubber, etc. on the core material surface.

As the fixing belt, polyamides, polyimides, polyethylene terephthalate, polybutylene terephthalate, and the like are used singly or in admixture of two or more kinds thereof. Also, examples of the coating resin of the roller or belt include homopolymers of styrenes (for example, styrene, p-chlorostyrene, and α-methylstyrene), α-methylene fatty acid monocarboxylic acids (for example, methyl acrylate, ethyl acrylate, n-propyl acrylate, lauryl acrylate, 2-ethylhexyl acrylate, methyl methacrylate, n-propyl methacrylate, lauryl methacrylate, and 2-ethylhexyl methacrylate), nitrogen-containing acryls (for example, dimethylaminoethyl methacrylate), vinylnitriles (for example, acrylonitrile and methacrylonitrile), vinylpyridines (for example, 2-vinylpyridine and 4-vinylpyridine), vinyl ethers (for example, vinyl methyl ether and vinyl isobutyl ether), vinyl ketones (for example, vinyl methyl ketone, vinyl ethyl ketone, and vinyl isopropenyl ketone), olefins (for example, ethylene and propylene), vinyl based fluorine-containing monomers (for example, vinylidene fluoride, tetrafluoroethylene, and hexafluoroethylene), etc. or copolymers composed of two or more kinds of these monomers; silicones such as methyl silicone and methylphenyl silicone; polyesters containing bisphenol, glycol, etc.; epoxy resins; polyurethane resins; polyamide resins; cellulose resins; polyether resins; and polycarbonate resins. These resins may be used singly or in combinations of two or more kinds thereof. Specific examples thereof which can be used include polytetrafluoroethylene, homopolymers of a fluorine-containing compound (for example, vinylidene fluoride and ethylene fluoride) and/or copolymers thereof, and homopolymers of an unsaturated hydrocarbon (for example, ethylene and propylene) and/or copolymers thereof.

Examples of the fixing substrate onto which the toner is fixed include papers and resin films. As the fixing paper, coat papers prepared by coating a resin partially or entirely on the surface of paper can be used. Also, as the resin film for fixing, resin-coated films in which the surface is coated partially or entirely by other kind of resin can be used. Also, for the purposes of preventing double feeding generated friction of the resin film and/or static electricity caused by friction and preventing the matter that the releasing agent elutes into an interface between the fixing substrate and the fixed image at the time of fixing to worsen adhesion of the fixed image, resin particles or inorganic particles can be added.

Specific examples of coating resins of paper or resin films include styrenes (for example, styrene, p-chlorostyrene, and α-methylstyrene); α-methylene fatty acid monocarboxylic acids (for example, methyl acrylate, ethyl acrylate, n-propyl acrylate, lauryl acrylate, 2-ethylhexyl acrylate, methyl methacrylate, n-propyl methacrylate, lauryl methacrylate, and 2-ethylhexyl methacrylate), nitrogen-containing acryls (for example, dimethylaminoethyl methacrylate), vinyl-nitriles (for example, acrylonitrile and methacrylonitrile), vinylpyridines (for example, 2-vinylpyridine and 4-vinyl-pyridine), vinyl ethers (for example, vinyl methyl ether and vinyl isobutyl ether), vinyl ketones (for example, vinyl methyl ketone, vinyl ethyl ketone, and vinyl isopropenyl ketone), olefins (for example, ethylene and propylene), vinyl based fluorine-containing monomers (for example, vinylidene fluoride, tetrafluoroethylene, and hexafluoroethylene), etc. or copolymers composed of two or more kinds of these monomers; silicones such as methyl silicone and methylphenyl silicone; polyesters containing bisphenol, glycol, etc.; epoxy resins; polyurethane resins; polyamide resins; cellulose resins; polyether resins; and polycarbonate resins. These resins may be used singly or in combinations of two or more kinds thereof.

Also, as specific examples of the inorganic particles, all of particles that are usually used as an external additive of the toner surface, such as silica, titania, calcium carbonate, magnesium carbonate, tricalcium phosphate, and cerium oxide, can be used. As the resin particles, all of particles that are usually used as an external additive of the toner surface, such as vinyl based resins, polyester resins, and silicone resins, can be used. Incidentally, these inorganic particles or organic particles can also be used as fluid aids, cleaning aids, etc.

### EXAMPLES

The invention will be specifically described below with reference to the following Examples, but it should not be construed that the invention is limited thereto. Incidentally, in the following description, all “parts” mean a “part by weight”.

A variety of measurements in the production of toners for use in the development of electrostatic latent images, carriers and developers for use in the development of electrostatic latent images as used in the respective Examples and Comparative Examples are carried out in the following methods.

### (Measurement of Arithmetic Average Height of Toner)

The arithmetic average height of toner is measured using a super-depth color 3-D shape measuring microscope VK-9500, manufactured by Keyence Corporation. In this device, a sample toner is irradiated with laser and subjected to three-dimensional scanning. The laser reflected light is monitored at every position using a CCD camera, to obtain three-dimensional surface information of the sample. The resulting surface information is statistically processed to determine an index regarding the surface roughness. In the present measurement, the surface of one toner is three-dimensionally measured over a 2 mm-square in the lengthwise and breadthwise directions (within the XY-axes plane) in a visual field of a lens magnification of 300 times under a scanning condition at a laser scanning pitch of 0.01 μm in the height direction (Z-axis direction), thereby determining an arithmetic average height of toner per toner. Also, in the measurement, γ=0.3 is employed for the γ correction, and for the noise cut analysis, a smoothening treatment of height is carried out once to determine a surface roughness. This operation is carried out for the measurement of 1,000 toners, and the resulting data are statistically processed to determine an arithmetic average height distribution of toner.

### (Measurement of Number Average Particle Size, Fluctuation of Number Average Particle Size, Average Circularity, and Fluctuation of Average Circularity)

FPIA-2100, manufactured by Sysmex Corporation is used for the measurement of number average particle size, fluctuation of number average particle size, average circularity, and fluctuation of average circularity of toner. In this device, a system in which particles dispersed in water, etc. are measured by the flow image analysis method is employed, a sucked particle suspension is introduced into a flat sheath flow cell and formed into a flat sample flow by a sheath liquid. By irradiating the sample flow with a strobe light, the particles under passing are photographed as a static image by a CCD camera through an objective lens.

The photographed particle image is subjected to two-dimensional image processing, and an equivalent circle diameter and a circularity are calculated from the projected area and peripheral length. With respect to the equivalent circle diameter, a diameter of a circle having the same area is calculated as an equivalent circle diameter from the area of the two-dimensional image regarding each of the photographed particles. At least 5,000 of the thus photographed particles are each subjected to image analysis and statistically processed to determine a number average particle size and a fluctuation of number average particle size. Also, with respect to the circularity, the circularity is determined regarding each of the photographed particles according to the following expression. Also, with respect to the circularity, at least 5,000 of the photographed particles are each subjected to image analysis and statistically processed to determine an average circularity and a fluctuation of average circularity.

[Circularity]=[Peripheral length of equivalent circle diameter]/[Peripheral length]=[2×(Aπ)^{1/2}]/PM

In the expression, A represents a projected area of a particle; and PM represents a peripheral length of a particle.

Incidentally, in the measurement, an HPF mode (high resolution mode) is used, and the dilution ratio is set up at 1.0 time. Also, in analyzing the data, for the purpose of removing measurement noises, the analysis range of number particle size is chosen within the range of from 2.0 to 30.1 μm, and the analysis range of circularity is chosen within the range of from 0.40 to 1.00.

### (Measurement of Primary Particle Size of External Additive and its Standard Deviation)

A laser diffraction/scattering type particle size distribution analyzer (LA-920, manufactured by Horiba, Ltd.) is used for the measurement.

### (Preparation of Colored Particles)

### —Preparation of Resin Dispersion (1)—

Styrene: 370 parts
n-Butyl acrylate: 90 parts
Acrylic acid: 8 parts
Dodecanethiol: 24 parts
Carbon tetrabromide: 4 parts

In a flask, a polymerizable composition prepared by mixing and dissolving the foregoing components is emulsified and dispersed in an aqueous solution of 6 parts of a nonionic surfactant (NONIPOL 400, manufactured by Sanyo Chemical Industries, Ltd.) and 10 parts of an anionic surfactant (NEOGEN SC, manufactured by Dai-ichi Kogyo Seiyaku Co., Ltd.) dissolved in 550 parts of ion-exchanged water, and 50 parts of ion-exchanged water having 4 parts of ammonium persulfate dissolved therein is thrown into the dispersion over 20 minutes while slowly mixing. After purging with nitrogen, the flask is heated in an oil bath until the temperature of the contents reached 70° C. while stirring within the flask, and emulsion polymerization is continued for 4 hours as it is.

As a result, there is thus obtained a resin dispersion (1) having dispersed therein resin particles having a average particle size of 165 nm, a glass transition temperature (Tg) of 57° C., and a weight average molecular weight (Mw) of 13,000.

### —Preparation of Resin Dispersion (2)—

Styrene: 340 parts
n-Butyl acrylate: 50 parts
Acrylic acid: 6 parts
Dodecanethiol: 6 parts
Carbon tetrabromide: 4 parts

In a flask, a polymerizable composition prepared by mixing and dissolving the foregoing components is emulsified and dispersed in an aqueous solution of 6 parts of a nonionic surfactant (NONIPOL 400, manufactured by Sanyo Chemical Industries, Ltd.) and 12 parts of an anionic surfactant (NEOGEN SC, manufactured by Dai-ichi Kogyo Seiyaku Co., Ltd.) dissolved in 550 parts of ion-exchanged water, and 50 parts of ion-exchanged water having 3 parts of ammonium persulfate dissolved therein is thrown into the dispersion over 10 minutes while slowly mixing. After purging with nitrogen, the flask is heated in an oil bath until the temperature of the contents reached 70° C. while stirring within the flask, and emulsion polymerization is continued for 5 hours as it is.

As a result, there is thus obtained a resin dispersion (2) having dispersed therein resin particles having a average particle size of 215 nm, a glass transition temperature (Tg) of 64.8° C., and a weight average molecular weight (Mw) of 49,000.

### —Preparation of Resin Dispersion (3)—

Styrene: 330 parts
n-Butyl acrylate: 60 parts
Acrylic acid: 6 parts
Dodecanethiol: 5 parts
Carbon tetrabromide: 4 parts

In a flask, a polymerizable composition prepared by mixing and dissolving the foregoing components is emulsified and dispersed in an aqueous solution of 6 parts of a nonionic surfactant (NONIPOL 400, manufactured by Sanyo Chemical Industries, Ltd.) and 10 parts of an anionic surfactant (NEOGEN SC, manufactured by Dai-ichi Kogyo Seiyaku Co., Ltd.) dissolved in 550 parts of ion-exchanged water, and 50 parts of ion-exchanged water having 4 parts of ammonium persulfate dissolved therein is thrown into the dispersion over 20 minutes while slowly mixing. After purging with nitrogen, the flask is heated in an oil bath until the temperature of the contents reached 80° C. while stirring within the flask, and emulsion polymerization is continued for 5 hours as it is.

As a result, there is thus obtained a resin dispersion (3) having dispersed therein resin particles having a average particle size of 185 nm, a glass transition temperature (Tg) of 62.3° C., and a weight average molecular weight (Mw) of 47,200.

### —Preparation of Resin Dispersion (4)—

Styrene: 315 parts
n-Butyl acrylate: 90 parts
Acrylic acid: 6 parts
Dodecanethiol: 6 parts
Carbon tetrabromide: 4 parts

In a flask, a polymerizable composition prepared by mixing and dissolving the foregoing components is emulsified and dispersed in an aqueous solution of 6 parts of a nonionic surfactant (NONIPOL 400, manufactured by Sanyo Chemical Industries, Ltd.) and 10 parts of an anionic surfactant (NEOGEN SC, manufactured by Dai-ichi Kogyo Seiyaku Co., Ltd.) dissolved in 550 parts of ion-exchanged water, and 50 parts of ion-exchanged water having 4 parts of ammonium persulfate dissolved therein is thrown into the dispersion over 20 minutes while slowly mixing. After purging with nitrogen, the flask is heated in an oil bath until the temperature of the contents reached 80° C. while stirring within the flask, and emulsion polymerization is continued for 5 hours as it is.

As a result, there is thus obtained a resin dispersion (4) having dispersed therein resin particles having a average particle size of 171 nm, a glass transition temperature (Tg) of 54.0° C., and a weight average molecular weight (Mw) of 34,300.

### —Preparation of Resin Dispersion (5)—

Styrene: 290 parts
n-Butyl acrylate: 100 parts
Acrylic acid: 6 parts
Dodecanethiol: 6 parts
Carbon tetrabromide: 4 parts

In a flask, a polymerizable composition prepared by mixing and dissolving the foregoing components is emulsified and dispersed in an aqueous solution of 6 parts of a nonionic surfactant (NONIPOL 400, manufactured by Sanyo Chemical Industries, Ltd.) and 10 parts of an anionic surfactant (NEOGEN SC, manufactured by Dai-ichi Kogyo Seiyaku Co., Ltd.) dissolved in 550 parts of ion-exchanged water, and 50 parts of ion-exchanged water having 4 parts of ammonium persulfate dissolved therein is thrown into the dispersion over 20 minutes while slowly mixing. After purging with nitrogen, the flask is heated in an oil bath until the temperature of the contents reached 80° C. while stirring within the flask, and emulsion polymerization is continued for 5 hours as it is.

As a result, there is thus obtained a resin dispersion (5) having dispersed therein resin particles having a average particle size of 125 nm, a glass transition temperature (Tg) of 48.1° C., and a weight average molecular weight (Mw) of 32,500.

### —Preparation of Coloring Agent Dispersion (1)—

Cyan pigment (C.I. Pigment Blue B15:3): 70 parts
Nonionic surfactant (NONIPOL 400, manufactured 5 parts by Sanyo Chemical Industries, Ltd.):
Ion-exchange water: 200 parts

The foregoing components are mixed and dissolved, and then dispersed for 10 minutes using a homogenizer (ULTRA-TURRAX T50, manufactured by IKA-Werke GmbH Co., KG). There is thus prepared a coloring agent dispersion (1) having dispersed therein particles of the coloring agent (cyan pigment) having a average particle size of 220 nm.

### —Preparation of Coloring Agent Dispersion (2)—

Magenta pigment (C.I. Pigment Red 122): 70 parts
Nonionic surfactant (NONIPOL 400, manufactured 5 parts by Sanyo Chemical Industries, Ltd.):
Ion-exchange water: 200 parts

The foregoing components are mixed and dissolved, and then dispersed for 10 minutes using a homogenizer (ULTRA-TURRAX T50, manufactured by IKA-Werke GmbH Co., KG). There is thus prepared a coloring agent dispersion (2) having dispersed therein particles of the coloring agent (magenta pigment) having a average particle size of 210 nm.

### —Preparation of Coloring Agent Dispersion (3)—

Yellow pigment (C.I. Pigment Yellow 180): 100 parts
Nonionic surfactant (NONIPOL 400, manufactured 5 parts by Sanyo Chemical Industries, Ltd.):
Ion-exchange water: 200 parts

The foregoing components are mixed and dissolved, and then dispersed for 10 minutes using a homogenizer (ULTRA-TURRAX T50, manufactured by IKA-Werke GmbH Co., KG). There is thus prepared a coloring agent dispersion (3) having dispersed therein particles of the coloring agent (yellow pigment) having a average particle size of 250 nm.

### —Preparation of Coloring Agent Dispersion (4)—

Carbon black (MOGUL L, manufactured by Cabot 50 parts Corporation):
Nonionic surfactant (NONIPOL 400, manufactured 5 parts by Sanyo Chemical Industries, Ltd.):
Ion-exchange water: 200 parts

The foregoing components are mixed and dissolved, and then dispersed for 10 minutes using a homogenizer (ULTRA-TURRAX T50, manufactured by IKA-Werke GmbH Co., KG). There is thus prepared a coloring agent dispersion (4) having dispersed therein particles of the coloring agent (black pigment) having a average particle size of 220 nm.

### —Preparation of Releasing Agent Dispersion (1)—

Paraffin wax (HNPO 190, manufactured by Nippon 50 parts Seiro Co., Ltd., melting point: 85° C.):
Cationic surfactant (SANISOL B50, manufactured 5 parts by Kao Corporation):
Ion-exchange water: 200 parts

In a round bottom stainless steel-made flask, the foregoing components are dispersed for 10 minutes using a homogenizer (ULTRA-TURRAX T50, manufactured by IKA-Werke GmbH Co., KG) and then subjected to a dispersion treatment using a pressure discharge type homogenizer. There is thus obtained a releasing agent dispersion (1) having dispersed therein releasing agent particles having a average particle size of 160 nm.

### —Preparation of Colored Particles 1—

Resin dispersion (5): 150 parts
Coloring agent dispersion (1): 200 parts
Releasing agent dispersion (1) 40 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by IKA-Werke GmbH Co., KG), the temperature is then raised to 48° C. over 150 minutes using an oil bath for heating while stirring within the flask, and the temperature is further raised to 52° C. over 100minutes. 50 parts of the resin dispersion (2) and 50 parts of the resin dispersion (3) are added at 52° C., and after allowing it to stand for 15 minute, 3 parts of an anionic surfactant (NEOGEN RK, manufactured by Dai-ichi Kogyo Seiyaku Co., Ltd.) is added. The stainless steel-made flask is sealed and heated to 93° C. using a magnetic force seal while continuing stirring, followed by keeping at 93° C. for 5 hours. After cooling, the reaction product is filtered, thoroughly ished with ion-exchanged water, and then dried to obtain colored particles 1.

### —Preparation of Colored Particles 2—

Colored fine particles 2 are obtained in the same manner as in the foregoing preparation of colored fine particles I, except that in the preparation of colored fine particles 1, the coloring agent dispersion (2) is used in place of the coloring agent dispersion (1).

### —Preparation of Colored Particles 3—

Colored particles 3 are obtained in the same manner as in the foregoing preparation of colored particles 1, except that in the preparation of colored particles 1, the coloring agent dispersion (3) is used in place of the coloring agent dispersion (1).

### —Preparation of Colored Particles 4—

Colored particles 4 are obtained in the same manner as in the foregoing preparation of colored particles 1, except that in the preparation of colored particles 1, the coloring agent dispersion (4) is used in place of the coloring agent dispersion (1).

### —Preparation of Colored Particles 5—

Resin dispersion (1): 180 parts
Coloring agent dispersion (1): 250 parts
Releasing agent dispersion (1) 50 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by TKA-Werke GmbH Co., KG), and the temperature is then raised to 60° C. over 300 minutes using an oil bath for heating while stirring within the flask. 50 parts of the resin dispersion (5) is added at 60° C., and after allowing it to stand for 15 minute, 3 parts of an anionic surfactant (NEOGEN RK, manufactured by Dai-ichi Kogyo Seiyaku Co., Ltd.) is added. The stainless steel-made flask is sealed and heated to 93° C. using a magnetic force seal while continuing stirring, followed by keeping at 93° C. for 5 hours. After cooling, the reaction product is filtered, thoroughly washed with ion-exchanged water, and then dried to obtain colored particles 5.

### —Preparation of Colored Particles 6—

Colored particles 6 are obtained in the same manner as in the foregoing preparation of colored particles 5, except that in the preparation of colored particles 5, the coloring agent dispersion (2) is used in place of the coloring agent dispersion (1).

### —Preparation of Colored Particles 7—

Colored particles 7 are obtained in the same manner as in the foregoing preparation of colored particles 5, except that in the preparation of colored particles 5, the coloring agent dispersion (3) is used in place of the coloring agent dispersion (1).

### —Preparation of Colored Particles 8—

Colored particles 8 are obtained in the same manner as in the foregoing preparation of colored particles 5, except that in the preparation of colored particles 5, the coloring agent dispersion (4) is used in place of the coloring agent dispersion (1).

### —Preparation of Colored Particles 9—

Resin dispersion (1): 150 parts
Resin dispersion (2): 25 parts
Coloring agent dispersion (1): 200 parts
Releasing agent dispersion (1) 60 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by IKA-Werke GmbH Co., KG), and the temperature is then raised to 56° C. over 30 minutes using an oil bath for heating while stirring within the flask. 100 parts of the resin dispersion (4) is added at 56° C., and after allowing it to stand for 120 minute, 3 parts of an anionic surfactant (NEOGEN RK, manufactured by Dai-ichi Kogyo Seiyaku Co., Ltd.) is added. The stainless steel-made flask is sealed and heated to 96° C. using a magnetic force seal while continuing stirring, followed by keeping at 96° C. for 5 hours. After cooling, the reaction product is filtered, thoroughly washed with ion-exchanged water, and then dried to obtain colored particles 9.

### —Preparation of Colored Particles 10—

Colored particles 10 are obtained in the same manner as in the foregoing preparation of colored particles 9, except that in the preparation of colored particles 9, the coloring agent dispersion (2) is used in place of the coloring agent dispersion (1).

### —Preparation of Colored Particles 11—

Colored particles 11 are obtained in the same manner as in the foregoing preparation of colored particles 9, except that in the preparation of colored particles 9, the coloring agent dispersion (3) is used in place of the coloring agent dispersion (1).

### —Preparation of Colored Particles 12—

Colored particles 12 are obtained in the same manner as in the foregoing preparation of colored particles 9, except that in the preparation of colored particles 9, the coloring agent dispersion (4) is used in place of the coloring agent dispersion (1).
—Preparation of Colored Particles 13—
Resin dispersion (1): 100 parts
Resin dispersion (4): 100 parts
Coloring agent dispersion (1): 200 parts
Releasing agent dispersion (1) 30 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by IKA-Werke GmbH Co., KG), and the temperature is then raised to 52° C. over 100 minutes using an oil bath for heating while stirring within the flask. 100 parts of the resin dispersion (1) is added at 52° C., and after allowing it to stand for 200 minute, 3 parts of an anionic surfactant (NEOGEN RK, manufactured by Dai-ichi Kogyo Seiyaku Co., Ltd.) is added. The stainless steel-made flask is sealed and heated to 95° C. using a magnetic force seal while continuing stirring, followed by keeping at 95° C. for 5 hours. After cooling, the reaction product is filtered, thoroughly washed with ion-exchanged water, and then dried to obtain colored particles 13.

### —Preparation of Colored Particles 14—

Colored particles 14 are obtained in the same manner as in the foregoing preparation of colored particles 13, except that in the preparation of colored particles 13, the coloring agent dispersion (2) is used in place of the coloring agent dispersion (1).

### —Preparation of Colored Particles 15—

Colored particles 15 are obtained in the same manner as in the foregoing preparation of colored particles 13, except that in the preparation of colored particles 13, the coloring agent dispersion (3) is used in place of the coloring agent dispersion (1).

### —Preparation of Colored Particles 16—

Colored particles 16 are obtained in the same manner as in the foregoing preparation of colored particles 13, except that in the preparation of colored particles 13, the coloring agent dispersion (4) is used in place of the coloring agent dispersion (1).

### —Preparation of Colored Particles 17—

Resin dispersion (2): 150 parts
Coloring agent dispersion (1): 180 parts
Releasing agent dispersion (1) 40 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by TKA-Werke GmbH Co., KG), the temperature is then raised to 48° C. over 150 minutes using an oil bath for heating while stirring within the flask, and the temperature is further raised to 52° C. over 100 minutes. 75 parts of the resin dispersion (2) and 75 parts of the resin dispersion (3) are added at 52° C., and after allowing it to stand for 10 minute, 3 parts of an anionic surfactant (NEOGEN RK, manufactured by Dai-ichi Kogyo Seiyaku Co., Ltd.) is added. The stainless steel-made flask is sealed and heated to 90° C. using a magnetic force seal while continuing stirring, followed by keeping at 90° C. for one hour. After cooling, the reaction product is filtered, thoroughly ished with ion-exchanged water, and then dried to obtain colored particles 17.

### —Preparation of Colored Particles 18—

Colored particles 18 are obtained in the same manner as in the foregoing preparation of colored particles 17, except that in the preparation of colored particles 17, the coloring agent dispersion (2) is used in place of the coloring agent dispersion (1) .

### —Preparation of Colored Particles 19—

Colored particles 19 are obtained in the same manner as in the foregoing preparation of colored particles 17, except that in the preparation of colored particles 17, the coloring agent dispersion (3) is used in place of the coloring agent dispersion (1).

### —Preparation of Colored Particles 20—

Colored particles 20 are obtained in the same manner as in the foregoing preparation of colored particles 17, except that in the preparation of colored particles 17, the coloring agent dispersion (4) is used in place of the coloring agent dispersion (1).

### —Preparation of Colored Particles 21—

Resin dispersion (5): 150 parts
Coloring agent dispersion (1): 220 parts
Releasing agent dispersion (1) 50 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by IKA-Werke GmbH Co., KG), and the temperature is then raised to 50° C. over 150 minutes using an oil bath for heating while stirring within the flask. 75 parts of the resin dispersion (2) and 75 parts of the resin dispersion (3) are added at 50° C., and after allowing it to stand for 15 minute, 3 parts of an anionic surfactant (NEOGEN RK, manufactured by Dai-ichi Kogyo Seiyaku Co., Ltd.) is added. The stainless steel-made flask is sealed and heated to 93° C. using a magnetic force seal while continuing stirring, followed by keeping at 93° C. for 12 hours. After cooling, the reaction product is filtered, thoroughly washed with ion-exchanged water, and then dried to obtain colored particles 21.

### —Preparation of Colored Particles 22—

Colored particles 22 are obtained in the same manner as in the foregoing preparation of colored particles 21, except that in the preparation of colored particles 21, the coloring agent dispersion (2) is used in place of the coloring agent dispersion (1).

### —Preparation of Colored Particles 23—

Colored particles 23 are obtained in the same manner as in the foregoing preparation of colored particles 21, except that in the preparation of colored particles 21, the coloring agent dispersion (3) is used in place of the coloring agent dispersion (1).

### —Preparation of Colored Particles 24—

Colored particles 24 are obtained in the same manner as in the foregoing preparation of colored particles 21, except that in the preparation of colored particles 21, the coloring agent dispersion (4) is used in place of the coloring agent dispersion (1).

### —Preparation of Colored Particles 25—

Resin dispersion (1): 150 parts
Resin dispersion (2): 150 parts
Coloring agent dispersion (1): 190 parts
Releasing agent dispersion (1) 55 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by TKA-Werke GmbH Co., KG), and the temperature is then raised to 56° C. over 130 minutes using an oil bath for heating while stirring within the flask. 100 parts of the resin dispersion (5) is added at 56° C., and after allowing it to stand for 10 minute, 3 parts of an anionic surfactant (NEOGEN RK, manufactured by Dai-ichi Kogyo Seiyaku Co., Ltd.) is added. The stainless steel-made flask is sealed and heated to 96° C. using a magnetic force seal while continuing stirring, followed by keeping at 96° C. for 3 hours. After cooling, the reaction product is filtered, thoroughly washed with ion-exchanged water, and then dried to obtain colored particles 25.

### —Preparation of Colored Particles 26—

Colored particles 26 are obtained in the same manner as in the foregoing preparation of colored particles 25, except that in the preparation of colored particles 25, the coloring agent dispersion (2) is used in place of the coloring agent dispersion (1).

### —Preparation of Colored Particles 27—

Colored particles 27 are obtained in the same manner as in the foregoing preparation of colored particles 25, except that in the preparation of colored particles 25, the coloring agent dispersion (3) is used in place of the coloring agent dispersion (1).

### —Preparation of Colored Particles 28—

Colored particles 28 are obtained in the same manner as in the foregoing preparation of colored particles 25, except that in the preparation of colored particles 25, the coloring agent dispersion (4) is used in place of the coloring agent dispersion (1).

### —Preparation of Colored Particles 29—

Resin dispersion (2): 100 parts
Resin dispersion (3): 100 parts
Coloring agent dispersion (1): 200 parts
Releasing agent dispersion (1) 70 parts
Cationic surfactant (SANISOL B50, manufactured 1.5 parts by Kao Corporation):

In a round bottom stainless steel-made flask, the foregoing components are mixed and dispersed using a homogenizer (ULTRA-TURRAX T50, manufactured by TKA-Werke GmbH Co., KG), and the temperature is then raised to 52° C. over 100 minutes using an oil bath for heating while stirring within the flask. 100 parts of the resin dispersion (5) is added at 52° C., and after allowing it to stand for 20 minute, 3 parts of an anionic surfactant (NEOGEN RK, manufactured by Dai-ichi Kogyo Seiyaku Co., Ltd.) is added. The stainless steel-made flask is sealed and heated to 90° C. using a magnetic force seal while continuing stirring, followed by keeping at 90° C. for 10 hours. After cooling, the reaction product is filtered, thoroughly washed with ion-exchanged water, and then dried to obtain colored particles 29.

### —Preparation of Colored Particles 30—

Colored particles 30 are obtained in the same manner as in the foregoing preparation of colored particles 29, except that in the preparation of colored particles 29, the coloring agent dispersion (2) is used in place of the coloring agent dispersion (1).

### —Preparation of Colored Particles 31—

Colored particles 31 are obtained in the same manner as in the foregoing preparation of colored particles 29, except that in the preparation of colored particles 29, the coloring agent dispersion (3) is used in place of the coloring agent dispersion (1).

### —Preparation of Colored Particles 32—

Colored particles 32 are obtained in the same manner as in the foregoing preparation of colored particles 29, except that in the preparation of colored particles 29, the coloring agent dispersion (4) is used in place of the coloring agent dispersion (1).

### (Preparation of External Additive)

### —External Additive 1—

Commercially available silica particles having a volume average particle size of 40 nm and a fluctuation coefficient of 60.5 is defined as an external additive 1.

### —External Additive 2—

A silica sol prepared by the sol-gel method is subjected to an HMDS treatment and then dried and pulverized to obtain a monodispersed silica external additive 2 having a volume average particle size of 120 nm and a fluctuation coefficient of 20.5.

—External additive 3—
Preparation of monodispersed spherical organic resin particles:

A separable flask having an inner volume of 2,000 mL and equipped with a stirrer, a nitrogen introducing pipe and a reflux condenser are charged with 1,000 parts of ion-exchanged water, 100 parts of styrene, 50 parts of trimethylolpropane (meth)acrylate, and 0.1 parts of a reactive surfactant (a trade name: HS-10, manufactured by Dai-ichi Kogyo Seiyaku Co., Ltd.) . The temperature is raised to 70° C. under a nitrogen gas stream in a certain stirring state, and after lapsing 30 minutes, 0.7 parts of ammonium persulfate as a polymerization initiator is added to initiate emulsion polymerization by radical polymerization reaction.

Thereafter, the emulsion polymerization is completed within about 24 hours while keeping the temperature of the reaction system at 70° C., to prepare an emulsion. Thereafter, nitric acid having a concentration of 1% by weight is dropped to adjust the pH of the reaction mixture at 4.0. Next, the resulting emulsion is dried overnight using a freeze dryer. There is thus obtained an external additive 3 as monodispersed spherical organic resin particles having a true specific gravity of 1.2, a volume average particle size of 130 nm, and a fluctuation coefficient of 30.5.

### (Production of Carrier)

Ferrite particles (volume average particle 100 parts size: 50 μm):
Toluene: 14 parts
Styrene-methacrylate copolymer (component 2 parts ratio: 90/10, Mw=80,000):
Carbon black (R330, manufactured by Cabot 0.2 parts Corporation):

First of all, the foregoing components except for the ferrite particles are stirred using a stirrer to prepare a dispersed coating liquid. Next, this coating liquid and the ferrite particles are charged in a vacuum deaeration type kneader, stirred at 60° C. for 30 minutes, and deaerated and dried in vacuo while heating to obtain a carrier.

### Example 1

3 parts of the external additive 1 is added to 100 parts of each of the black, cyan, magenta and yellow toners of the colored particles 1 to 4 and blended using a Henschel mixer at a peripheral speed of 45 m/s for 10 minutes, and coarse particles are then removed using a sieve having a mesh size of 45 μm to obtain toners.

100 parts of the foregoing carrier is added to 5 parts of each of the toners and stirred using a V-blender at 40 rpm for 20 minutes, followed by screening using a sieve having a mesh size of 177 μm. There is thus obtained a developer 1 of one set having four colors.

### Example 2

3 parts of the external additive 1 is added to 100 parts of each of the black, cyan, magenta and yellow toners of the colored particles 5 to 8 and blended using a Henschel mixer at a peripheral speed of 32 m/s for 12 minutes, and coarse particles are then removed using a sieve having a mesh size of 45 μm to obtain toners.

100 parts of the foregoing carrier is added to 5 parts of each of the toners and stirred using a V-blender at 40 rpm for 20 minutes, followed by screening using a sieve having a mesh size of 177 μm. There is thus obtained a developer 2 of one set having four colors.

### Example 3

3 parts of the external additive 1 is added to 100 parts of each of the black, cyan, magenta and yellow toners of the colored particles 9 to 12 and blended using a Henschel mixer at a peripheral speed of 32 m/s for 12 minutes, and coarse particles are then removed using a sieve having a mesh size of 45 μm to obtain toners.

100 parts of the foregoing carrier is added to 5 parts of each of the toners and stirred using a V-blender at 40 rpm for 20 minutes, followed by screening using a sieve having a mesh size of 177 μm. There is thus obtained a developer 3 of one set having four colors.

### Example 4

2 parts of the external additive 1 and 1 part of the external additive 2 are added to 100 parts of each of the black, cyan, magenta and yellow toners of the colored particles 13 to 16 and blended using a Henschel mixer at a peripheral speed of 32 m/s for 12 minutes, and coarse particles are then removed using a sieve having a mesh size of 45 μm to obtain toners.

100 parts of the foregoing carrier is added to 5 parts of each of the toners and stirred using a V-blender at 40 rpm for 20 minutes, followed by screening using a sieve having a mesh size of 177 μm. There is thus obtained a developer 4 of one set having four colors.

### Example 5

2 parts of the external additive 1 and 1 part of the external additive 3 are added to 100 parts of each of the black, cyan, magenta and yellow toners of the colored particles 13 to 16 and blended using a Henschel mixer at a peripheral speed of 32 m/s for 12 minutes, and coarse particles are then removed using a sieve having a mesh size of 45 μm to obtain toners.

100 parts of the foregoing carrier is added to 5 parts of each of the toners and stirred using a V-blender at 40 rpm for 20 minutes, followed by screening using a sieve having a mesh size of 177 μm. There is thus obtained a developer 5 of one set having four colors.

### Comparative Example 1

A developer 6 of one set having four colors is obtained in the same manner as in Example 1, except that in Example 1, the colored particles 17 to 20 are used in place of the colored particles 1 to 4.

### Comparative Example 2

A developer 7 of one set having four colors is obtained in the same manner as in Example 1, except that in Example 1, the colored particles 21 to 24 are used in place of the colored particles 1 to 4.

### Comparative Example 3

A developer 8 of one set having four colors is obtained in the same manner as in Example 1, except that in Example 1, the colored particles 25 to 28 are used in place of the colored particles 1 to 4.

### Comparative Example 4

A developer 9 of one set having four colors is obtained in the same manner as in Example 1, except that in Example 1, the colored particles 29 to 32 are used in place of the colored , particles 1 to 4.

A variety of physical properties values of these developers 1 to 9 are shown in Tables 1 and 2.

TABLE 1

| | | | | Median of | | Value of 90% | | |
|---|---|---|---|---|---|---|---|---|
| | | | | arithmetic | Fluctuation | accumulation | | Number average |
| | | | Average | average | of arithmetic | of arithmetic | Fluctuation | particle |
| | | | circularity | height (μm) | average height | average height (μm) | of circularity | size (μm) |
| Example 1 | Toner 1 | Colored | 0.979 | 0.102 | 28.3 | 0.151 | 2.51 | 5.59 |
| | | particles 1 | | | | | | |
| | Toner 2 | Colored | 0.975 | 0.115 | 29.8 | 0.155 | 2.60 | 5.77 |
| | | particles 2 | | | | | | |
| | Toner 3 | Colored | 0.978 | 0.108 | 31.2 | 0.152 | 2.58 | 5.80 |
| | | particles 3 | | | | | | |
| | Toner 4 | Colored | 0.980 | 0.110 | 30.9 | 0.154 | 2.59 | 5.64 |
| | | particles 4 | | | | | | |
| Example 2 | Toner 5 | Colored | 0.983 | 0.096 | 26.8 | 0.135 | 2.52 | 6.32 |
| | | particles 5 | | | | | | |
| | Toner 6 | Colored | 0.981 | 0.091 | 28.8 | 0.138 | 2.55 | 6.29 |
| | | particles 6 | | | | | | |
| | Toner 7 | Colored | 0.980 | 0.093 | 27.6 | 0.144 | 2.58 | 6.18 |
| | | particles 7 | | | | | | |
| | Toner 8 | Colored | 0.985 | 0.098 | 27.9 | 0.129 | 2.53 | 6.09 |
| | | particles 8 | | | | | | |
| Example 3 | Toner 9 | Colored | 0.981 | 0.080 | 30.2 | 0.123 | 1.60 | 6.82 |
| | | particles 9 | | | | | | |
| | Toner 10 | Colored | 0.983 | 0.085 | 31.3 | 0.118 | 1.55 | 6.59 |
| | | particles 10 | | | | | | |
| | Toner 11 | Colored | 0.986 | 0.083 | 31.2 | 0.115 | 1.60 | 6.78 |
| | | particles 11 | | | | | | |
| | Toner 12 | Colored | 0.985 | 0.088 | 30.2 | 0.116 | 1.63 | 6.59 |
| | | particles 12 | | | | | | |
| Example 4 | Toner 13 | Colored | 0.979 | 0.105 | 30.8 | 0.132 | 1.87 | 6.48 |
| | | particles 13 | | | | | | |
| | Toner 14 | Colored | 0.982 | 0.110 | 32.8 | 0.129 | 1.98 | 6.29 |
| | | particles 14 | | | | | | |
| | Toner 15 | Colored | 0.976 | 0.103 | 30.9 | 0.125 | 1.79 | 6.97 |
| | | particles 15 | | | | | | |
| | Toner 16 | Colored | 0.981 | 0.107 | 29.9 | 0.134 | 1.88 | 6.87 |
| | | particles 16 | | | | | | |
| Example 5 | Toner 17 | Colored | 0.981 | 0.108 | 28.5 | 0.138 | 1.90 | 6.43 |
| | | particles 13 | | | | | | |
| | Toner 18 | Colored | 0.984 | 0.111 | 28.8 | 0.134 | 2.00 | 6.32 |
| | | particles 14 | | | | | | |
| | Toner 19 | Colored | 0.979 | 0.105 | 27.9 | 0.133 | 1.83 | 6.92 |
| | | particles 15 | | | | | | |
| | Toner 20 | Colored | 0.980 | 0.110 | 29.3 | 0.137 | 1.94 | 6.83 |
| | | particles 16 | | | | | | |
| Comparative | Toner 21 | Colored | 0.965 | 0.135 | 52 | 0.225 | 3.28 | 5.98 |
| Example 1 | | particles 17 | | | | | | |
| | Toner 22 | Colored | 0.962 | 0.140 | 45 | 0.213 | 3.48 | 5.84 |
| | | particles 18 | | | | | | |
| | Toner 23 | Colored | 0.968 | 0.133 | 51 | 0.218 | 3.10 | 5.95 |
| | | particles 19 | | | | | | |
| | Toner 24 | Colored | 0.970 | 0.137 | 50 | 0.220 | 3.35 | 5.82 |
| | | particles 20 | | | | | | |
| Comparative | Toner 25 | Colored | 0.979 | 0.115 | 47 | 0.210 | 2.56 | 7.58 |
| Example 2 | | particles 21 | | | | | | |
| | Toner 26 | Colored | 0.980 | 0.119 | 45 | 0.205 | 2.57 | 7.21 |
| | | particles 22 | | | | | | |
| | Toner 27 | Colored | 0.976 | 0.118 | 48 | 0.214 | 2.58 | 7.34 |
| | | particles 23 | | | | | | |
| | Toner 28 | Colored | 0.978 | 0.110 | 43 | 0.208 | 2.57 | 7.22 |
| | | particles 24 | | | | | | |
| Comparative | Toner 29 | Colored | 0.977 | 0.133 | 32 | 0.161 | 2.88 | 6.19 |
| Example 3 | | particles 25 | | | | | | |
| | Toner 30 | Colored | 0.980 | 0.139 | 30 | 0.158 | 2.79 | 6.24 |
| | | particles 26 | | | | | | |
| | Toner 31 | Colored | 0.978 | 0.131 | 31 | 0.160 | 2.91 | 6.34 |
| | | particles 27 | | | | | | |
| | Toner 32 | Colored | 0.977 | 0.135 | 33 | 0.153 | 2.90 | 6.09 |
| | | particles 28 | | | | | | |
| Comparative | Toner 33 | Colored | 0.958 | 0.123 | 29 | 0.182 | 2.60 | 6.89 |
| Example 4 | | particles 29 | | | | | | |
| | Toner 34 | Colored | 0.959 | 0.129 | 29 | 0.194 | 2.64 | 6.94 |
| | | particles 30 | | | | | | |
| | Toner 35 | Colored | 0.960 | 0.122 | 27 | 0.198 | 2.78 | 6.74 |
| | | particles 31 | | | | | | |
| | Toner 36 | Colored | 0.961 | 0.125 | 26 | 0.193 | 2.73 | 6.89 |
| | | particles 32 | | | | | | |

TABLE 2

| | | | | | | Transfer | | | |
|---|---|---|---|---|---|---|---|---|---|
| | | | Fluctuation | Particle size | Initial | efficiency | | | |
| | | | of number | of large | transfer | after copying | Evaluation | | Deposits on |
| | | | average | size external | efficiency | of 50,000 | of transfer | Image | photo- |
| | | | particle size | additive (μm) | (%) | sheets (%) | efficiency | ghost | receptor |
| Example 1 | Toner 1 | Colored | 26.2 | 0.04 | 92.2 | 91.8 | ◯ | ◯ | ◯ |
| | | particles 1 | | | | | | | |
| | Toner 2 | Colored | 27.0 | 0.04 | | | | | |
| | | particles 2 | | | | | | | |
| | Toner 3 | Colored | 28.3 | 0.04 | | | | | |
| | | particles 3 | | | | | | | |
| | Toner 4 | Colored | 27.1 | 0.04 | | | | | |
| | | particles 4 | | | | | | | |
| Example 2 | Toner 5 | Colored | 26.2 | 0.04 | 93.8 | 83.2 | ◯ | ◯ | ◯ |
| | | particles 5 | | | | | | | |
| | Toner 6 | Colored | 26.8 | 0.04 | | | | | |
| | | particles 6 | | | | | | | |
| | Toner 7 | Colored | 27.7 | 0.04 | | | | | |
| | | particles 7 | | | | | | | |
| | Toner 8 | Colored | 28.1 | 0.04 | | | | | |
| | | particles 8 | | | | | | | |
| Example 3 | Toner 9 | Colored | 19.1 | 0.04 | 96.4 | 85.2 | ⊙ | ⊙ | ◯ |
| | | particles 9 | | | | | | | |
| | Toner 10 | Colored | 18.7 | 0.04 | | | | | |
| | | particles 10 | | | | | | | |
| | Toner 11 | Colored | 18.6 | 0.04 | | | | | |
| | | particles 11 | | | | | | | |
| | Toner 12 | Colored | 19.2 | 0.04 | | | | | |
| | | particles 12 | | | | | | | |
| Example 4 | Toner 13 | Colored | 19.1 | 0.13 | 96.5 | 88.1 | ⊙ | ⊙ | ◯ |
| | | particles 13 | | | | | | | |
| | Toner 14 | Colored | 19.2 | 0.13 | | | | | |
| | | particles 14 | | | | | | | |
| | Toner 15 | Colored | 18.2 | 0.13 | | | | | |
| | | particles 15 | | | | | | | |
| | Toner 16 | Colored | 20.0 | 0.13 | | | | | |
| | | particles 16 | | | | | | | |
| Example 5 | Toner 17 | Colored | 19.3 | 0.15 | 98.2 | 92.5 | ⊙ | ⊙ | ⊙ |
| | | particles 13 | | | | | | | |
| | Toner 18 | Colored | 18.9 | 0.15 | | | | | |
| | | particles 14 | | | | | | | |
| | Toner 19 | Colored | 18.5 | 0.15 | | | | | |
| | | particles 15 | | | | | | | |
| | Toner 20 | Colored | 20.4 | 0.15 | | | | | |
| | | particles 16 | | | | | | | |
| Comparative | Toner 21 | Colored | 35.8 | 0.04 | 80.6 | 68.2 | X | X | X |
| Example 1 | | particles 17 | | | | | | | |
| | Toner 22 | Colored | 30.3 | 0.04 | | | | | |
| | | particles 18 | | | | | | | |
| | Toner 23 | Colored | 29.9 | 0.04 | | | | | |
| | | particles 19 | | | | | | | |
| | Toner 24 | Colored | 31.4 | 0.04 | | | | | |
| | | particles 20 | | | | | | | |
| Comparative | Toner 25 | Colored | 32.8 | 0.04 | 82.3 | 73.8 | X | Δ | X |
| Example 2 | | particles 21 | | | | | | | |
| | Toner 26 | Colored | 33.8 | 0.04 | | | | | |
| | | particles 22 | | | | | | | |
| | Toner 27 | Colored | 30.9 | 0.04 | | | | | |
| | | particles 23 | | | | | | | |
| | Toner 28 | Colored | 29.8 | 0.04 | | | | | |
| | | particles 24 | | | | | | | |
| Comparative | Toner 29 | Colored | 26.8 | 0.04 | 83.1 | 71.8 | X | Δ | X |
| Example 3 | | particles 25 | | | | | | | |
| | Toner 30 | Colored | 27.8 | 0.04 | | | | | |
| | | particles 26 | | | | | | | |
| | Toner 31 | Colored | 28.9 | 0.04 | | | | | |
| | | particles 27 | | | | | | | |
| | Toner 32 | Colored | 29.4 | 0.04 | | | | | |
| | | particles 28 | | | | | | | |
| Comparative | Toner 33 | Colored | 28.5 | 0.04 | 81.8 | 70.2 | X | Δ | X |
| Example 4 | | particles 29 | | | | | | | |
| | Toner 34 | Colored | 27.9 | 0.04 | | | | | |
| | | particles 30 | | | | | | | |
| | Toner 35 | Colored | 25.8 | 0.04 | | | | | |
| | | particles 31 | | | | | | | |
| | Toner 36 | Colored | 27.3 | 0.04 | | | | | |
| | | particles 32 | | | | | | | |

The transfer properties and images are evaluated using DocuPrint-C1616, manufactured by Fuji Xerox Co., Ltd. The DocuPrint-C1616 is provided with a brush cleaner but not a blade cleaner on a photoreceptor. Also, the DocuPrint-C1616 employs a contact charge system as a charge system of photoreceptor. Further, the DocuPrint-C1616 uses an intermediate transfer body and employs a multi layer transfer system.

First of all, each of the foregoing developers having a toner concentration of 5% by weight is received in a developing unit of the foregoing image forming device and allowed to stand in the circumstance at a temperature of 30° C. and a humidity of 90% RH for 72 hours. Thereafter, the development condition is set up such that the development amount of the toner of each color on the surface of the photoreceptor could be kept in the range of from 40 to 50 g/m² at the time of evaluation. The transfer properties are evaluated by determining a proportion of the amount of the recovered toner to the amount of the used toner. Specifically, the consumption amount (a) of the toner used for the evaluation is determined from a change in the weight of a toner cartridge before and after the evaluation; the residual amount (b) of the toner after transfer is determined from a change in the weight of a waste toner recover boxy before and after the evaluation; and the transfer efficiency is determined according to the following expression.

[Transfer efficiency η (%)]=[a/b]×100

In this system, the transfer efficiency counts not only the transfer residual amount on the photoreceptor but also the transfer residual amount on the intermediate transfer body and becomes a severe evaluation of the transfer efficiency in comparison with the case where only the transfer efficiency on the photoreceptor is evaluated.

The target transfer efficiency is 90% or more and is evaluated according to the following judgment criteria.
η≧90%: ⊙
85%≦η<90%: ◯
80%≦η85%: Δ
η<80%: ×

With respect to the evaluation, the image quality is evaluated at the initial stage and after copying of 50,000 sheets. With respect to the image quality, the presence or absence of the generation of image ghost after copying of 50,000 sheets is evaluated. Further, the surface of the photoreceptor after copying of 50,000 sheets is observed, and the presence of absence of deposits or scars is evaluated. The results are shown in Table 2.

The presence or absence of image ghost and deposits or scars on the photoreceptor is evaluated according to the following judgment criteria.
Ghost/deposits/scars are not substantially observed: ⊙
Ghost/deposits/scars are slightly observed: ◯
Ghost/deposits/scars are readily observed: Δ
Ghost/deposits/scars are much observed: ×

The developers 1 to 5 obtained in Examples 1 to 5 exhibited excellent transfer properties not only at the initial stage but also after copying of 50,000 sheets and all provided distinct images. Further, the surface state of the photoreceptor after copying of 50,000 sheets is good. In particular, in Example 5, the surface state is so clean that deposits or scars on the photoreceptor are not substantially observed.

On the other hand, in the developer 6 obtained in Comparative Example 1, the circularity of toner is small, the median of arithmetic average height distribution of the toner is large, and the fluctuation of arithmetic average height distribution is large. Accordingly, the adhesion state of the external additive is scattered among the toners. Thus, the transfer efficiency is rather low from the initial stage, and the transfer efficiency after copying of 50,000 sheets is low. In the developer 7 obtained in Comparative Example 2, since the fluctuation of arithmetic average height distribution is large, the transfer efficiency after copying of 50,000 sheets is low, and the maintenance of transfer is not obtained. In the developer 8 obtained in Comparative Example 3, since the median of arithmetic average height distribution of the toner is large, the transfer efficiency after copying of 50,000 sheets is low. Further, in the developer 9 obtained in Comparative Example 4, since the circularity of toner is small, the transfer efficiency after copying of 50,000 sheets is low, and the maintenance of transfer is not obtained.

What is claimed is:

1. A toner comprising colored particles,
wherein the toner has an average circularity of 0.975 or more, a median of arithmetic average height distribution of from 0.05 μm to 0.12 μm, and a fluctuation of arithmetic average height of 35 or less,
wherein the circularity is defined by:
[Circularity]=[Peripheral length of equivalent circle diameter]/[Peripheral length]=[2×(Aπ)^{1/2}]/PM
where A represents a projected area of a particle and PM represents a peripheral length of a particle;
wherein the toner has a fluctuation of number average particle size of not more than 25 and a fluctuation of circularity of not more than 2.5,
wherein a value of 90% accumulation of the arithmetic average height distribution of the toner is less than 0.15 μm,
wherein the colored particles include a binder resin having a weight average molecular weight of from 13,000 to 49,000, and
wherein the toner is prepared by an emulsion polymerization method.

2. The toner according to claim 1, further comprising an external additive having a median diameter of between 0.1 μm and 0.3 μm.

3. The toner according to claim 1, further comprising an external additive, wherein the external additive is at least one of monodispersed spherical silica and monodispersed spherical organic resin particles.

4. The toner according to claim 1, further comprising an external additive,
wherein at least one of monodispersed spherical silica and monodispersed spherical organic resin particles, and an additional amount of the monodispersed spherical silica is in a range of from 0.5 to 5 parts by weight based on 100 parts by weight of the colored particles.

5. The toner according to claim 3, wherein the monodispersed spherical organic resin particles have a gel fraction of 90% by weight or more.

6. The toner according to claim 1, wherein the colored particles include coloring agent particles and an external additive, wherein the coloring agent particles have a volume average particle size of not more than 0.8 μm.

7. The toner according to claim 1, which has a number average particle size in a range of from 5.0 to 7.0 μm.

8. A developer comprising a toner and a carrier,
wherein an average circularity of the toner is 0.975 or more, a median of arithmetic average height distribution of the toner is in a range of from 0.05 μm to 0.12 μm, and a fluctuation of arithmetic average height of the toner is 35 or less,
wherein the circularity is defined by:
[Circularity]=[Peripheral length of equivalent circle diameter]/[Peripheral length]=[2×(Aπ)^{1/2}]/Pm
where A represents a projected area of a particle and PM represents a peripheral length of a particle,
wherein the toner has a fluctuation of number average particle size of not more than 25 and a fluctuation of circularity of not more than 2.5,
wherein the carrier has a volume resistivity of greater than 10⁶ to less than 10¹⁴Ω·cm under 1000V,
wherein a value of 90% accumulation of the arithmetic average height distribution of the toner is less than 0.15 μm,
wherein the toner comprises colored particles, the colored particles including a binder resin having a weight average molecular weight of from 13,000 to 49,000, and
wherein the toner is prepared by an emulsion polymerization method.

9. The developer according to claim 8, wherein a true specific gravity of the carrier is in the range of from 3 to 4 and a saturation magnetization of the carrier under a condition of 5 kOe is 60 A·m²/kg or more.

10. The developer according to claim 8, wherein the carrier comprises a core material and a matrix resin layer including a matrix resin, and a conductive material is dispersed in the matrix resin.

11. The developer according to 10, wherein an average film thickness of the matrix resin layer is in a range of from 0.5 to 3 μm.
